(19) United States
(12) Patent Application Publication
(10) Pub. No.: US 2002/0053066 A1
(43) Pub. Date: May 2, 2002

(54) Circuit breaker mechanism modeling

(76) Inventors: Timothy Gerard Richter, Wynantskill, NY (US); Ahmed Elasser, Latham, NY (US); Jonathan David Potter, Southington, CT (US); Roger John Morgan, Farmington, CT (US)

Correspondence Address: Philmore H. Colburn II, Cantor Colburn LLP, 55 Griffin Road South, Blommfield, CT, 06002, US

(21) Appl. No.: 09/918,993

(22) Filed: Jul. 31, 2001

Related U.S. Application Data
(63) Continuation-in-part of application No. 09/528,175, filed on Mar. 17, 2000.

(51) Int. Cl. G06F 17/50

(52) U.S. Cl. 716/5; 716/8; 716/4

(57) ABSTRACT

A system for modeling a circuit breaker assembly and its components. The system comprises a computer generated and interactive system model, the system model comprising hierarchically arranged sub-models, each sub-model representing a different circuit breaker function, a first pin for passing simulated load current to the system model, and a second pin for passing simulated load current from the system model.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

CROSS-REFERENCE TO RELATED APPLICATIONS

This application is a continuation-in-part of U.S. patent application Ser. No. 09/528,175 entitled “CIRCUIT INTERRUPTION MODELING METHOD AND APPARATUS” filed Mar. 17, 2000, currently pending, which is hereby incorporated by reference in its entirety.

### BACKGROUND OF THE INVENTION

This invention relates generally to circuit breakers. More particularly, this invention relates to the modeling of mechanical components used in circuit breakers.

Circuit breakers are widely used in industry and residences to protect against fire and shock hazards when electrical wiring or equipment fails. Typically, a plurality of circuit interrupters are joined together as a circuit breaker, wherein each circuit interrupter corresponds to a phase of power within a multi-phase power system. The mechanical components of circuit breakers often interact in complicated ways. Despite their importance and intricate design, much of current mechanism design is developed using “cut and try” methods, based on experience.

To understand the behavior of circuit breakers at both the system level and the component level, circuit breakers are positioned between a power source and a load, and various fault conditions are generated. The conditions of the breaker immediately before the breaker starts to opens, and during opening, are generally studied with current and voltage curves for each phase. However, this approach can be time consuming, as the desired circuit breaker must be constructed and installed. Furthermore, the fault condition must be experimentally generated, which is also costly and time consuming.

### BRIEF SUMMARY OF THE INVENTION

The above discussed and other drawbacks and deficiencies of the prior art are overcome or alleviated by a system for modeling a circuit breaker assembly and its components.

In an exemplary embodiment of the invention, the system comprises a computer generated and interactive system model, the system model comprising hierarchically arranged sub-models, each sub-model representing a different circuit breaker finction, a first pin for passing simulated load current to the system model, and a second pin for passing simulated load current from the system model.

The above-discussed and other features and advantages of the present invention will be appreciated and understood by those skilled in the art from the following detailed description and drawings.

### BRIEF DESCRIPTION OF THE DRAWINGS

Referring to the exemplary drawings wherein like elements are numbered alike in the several FIGURES:

FIG. 1 is an isometric view of a molded case circuit breaker;

FIG. 2 is an exploded view of the circuit breaker of FIG. 1;

FIG. 3 is a partial sectional view of a rotary contact structure and operating mechanism;

FIG. 4 is an enlarged side view of a rotary contact structure in the “closed”: position;

FIG. 5 is an enlarged side view of a rotary contact structure in the “open” position;

FIG. 6 is an isometric view of an operating mechanism and an actuator employed within the molded case circuit breaker of FIGS. 1 and 2;

FIG. 7 is a partially exploded isometric view of the operating mechanism of FIG. 6;

FIG. 8 is an exploded isometric view of the operating mechanism of FIG. 6;

FIG. 9 is a block diagram of an exemplary electronic trip unit employed within the molded case circuit breaker of FIG. 1;

FIG. 10 is a flow diagram representing an embodiment of the modeling method and apparatus of the present invention;

FIG. 11 is a flow diagram representing an embodiment of subassembly model selection;

FIG. 12 is a component flow diagram of a circuit breaker model generally showing the sub-assembly models and respective component models;

FIG. 13 is a block diagram of circuit breaker functions;

FIG. 14 is an exemplary trip-time curve for trip units of a circuit breaker;

FIG. 15 is a perspective view of a circuit breaker assembly;

FIG. 16 is a perspective view of a bimetal strip for use in the circuit breaker assembly of FIG. 15;

FIG. 17 is a diagrammatic view of a bimetal trip model for use in the overall modeling system of this invention;

FIG. 18 is a schematic view of a bimetal heating model for use in the bimetal trip model of FIG. 17;

FIG. 19 is a snippet of code representing a bimetal deflection model for use in the bimetal trip model of FIG. 17;

FIG. 20 is a perspective view of the electronic trip unit linkage for use in the circuit breaker assembly of FIG. 15;

FIG. 21 is a schematic view of a solenoid mechanism model for use in the overall modeling system of this invention;

FIG. 22 is a schematic view of a magnetic trip model for use in the overall modeling system of this invention;

FIG. 23 is a perspective view of a latch for use in the circuit breaker assembly of FIG. 15;

FIG. 24 is a schematic view of a latch mechanism model for use in the overall modeling system of this invention;

FIG. 25 is a snippet of code representing a latch position model for use with the latch mechanism model of FIG. 24 and in the overall modeling system of this invention;

FIG. 26 is a schematic view of an operating mechanism model for use in the overall modeling system of this invention;

FIG. 27 is a snippet of code representing a spring coupling model for use with the operating mechanism model of FIG. 26 and in the overall modeling system of this invention;

FIG. 28 is a schematic view of the overall modeling system of this invention;

FIG. 29 is a schematic view of a symbol representing the overall modeling system of FIG. 28;

FIG. 30 is a schematic view of an exemplary short circuit test simulation using the overall modeling system of FIG. 28;

FIG. 31 is a graphical representation of the results of the short circuit test of FIG. 30;

FIG. 32 is a schematic view of an exemplary bimetal heating test simulation, demonstrating low-level testing and design, using the bimetal heating model of FIG. 18;

FIG. 33 is a graphical representation of the results of the bimetal heating test simulation of FIG. 32;

FIG. 34 is a screen capture representing the modeling system of FIG. 28 with the property editor; and,

FIG. 35 is a perspective view of a circuit breaker assembly in a tripped condition.

### DETAILED DESCRIPTION OF THE INVENTION

An approach for modeling the mechanical components of a circuit breaker is disclosed. Elemental, behavioral, transfer-function, and analytical models are used to model each component of the circuit breaker. The overall mechanical model can be integrated with electrical simulations to provide an entire model representing the behavior of the circuit breaker. The approach can be extended or modified to cover many types of circuit breakers. The modular approach can be scaled to include multi-pole circuit breakers or dissected to include one or several modules in another design.

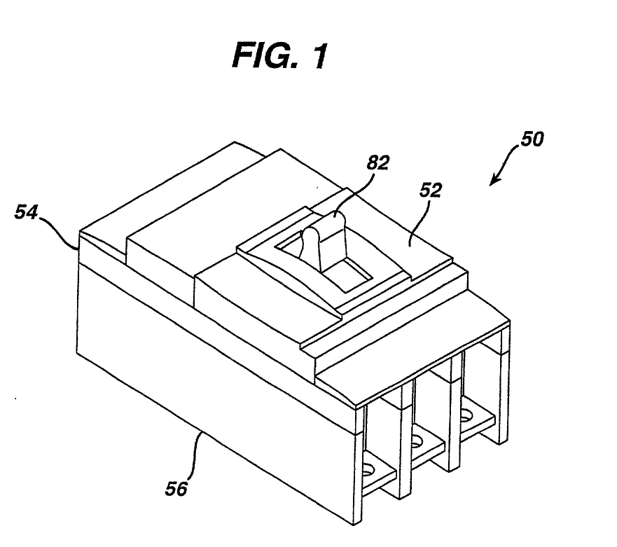

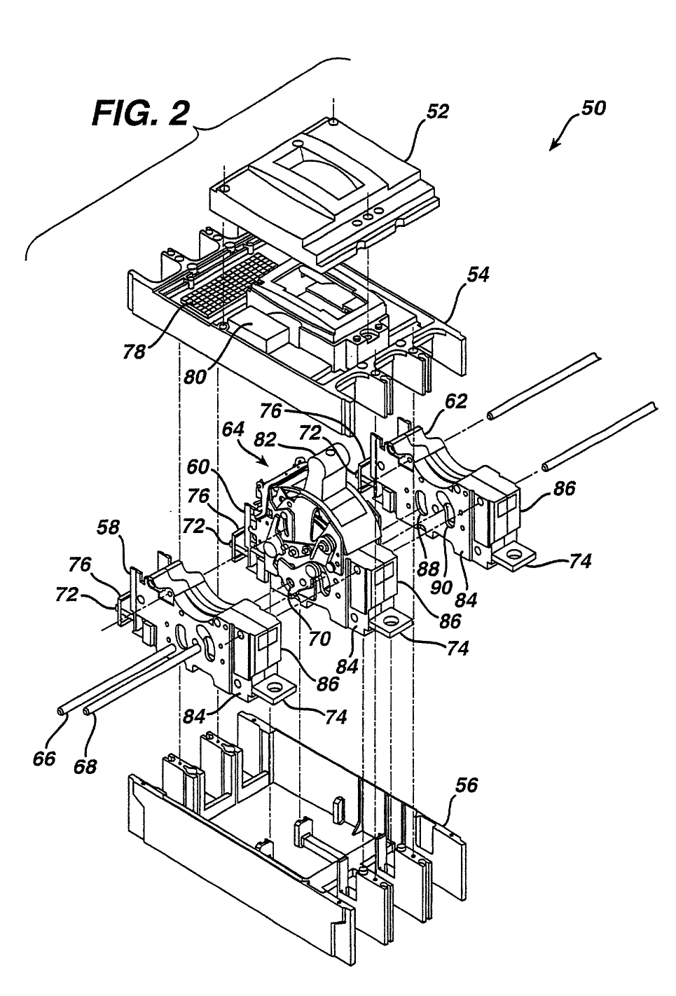

An exemplary multi-pole circuit breaker 50 is shown in FIGS. 1 and 2. Circuit breaker 50 generally includes a molded case including a top cover 52, a mid cover 54 and a base 56. A plurality of cassettes 58, 60 and 62 are disposed within base 56. An operating mechanism 64 is disposed atop cassette 60. Cassettes 58, 60 and 62 are commonly operated via a set of cross bars 66, 68. The crossbar 66 is disposed through an opening 70 in a portion of operating mechanism 64.

A line side contact strap 72 and a load side contact strap 74 extends from each cassette 58, 60 and 62 for connection with a power source and a protected circuit and/or load, respectively. A current transformer 76 is arranged relative to each line side contact strap 72. Current transformer 76 is coupled (not shown) to a trip unit 78 positioned within mid cover 54. Optionally, a rating plug (not shown) can be interfaced with trip unit 78 to change the settings of circuit breaker 50.

Trip unit 78 includes an actuator 80, which can be, for example, a flux actuator. Operating mechanism 64 includes a toggle handle 82 extends through openings within top cover 52 and mid cover 54. Toggle handle 82 provides external operation of operating mechanism 64.

Cassettes 58, 60, 62 are typically formed of high strength plastic material and each include opposing sidewalls 84, 86. Sidewalls 84, 86 have a pair of arcuate slots 88, 90 positioned and configured to receive and allow the motion of cross bars 66, 68 by operating mechanism 64. Operating mechanism 64 is thus suitable for operating rotary contact structures.

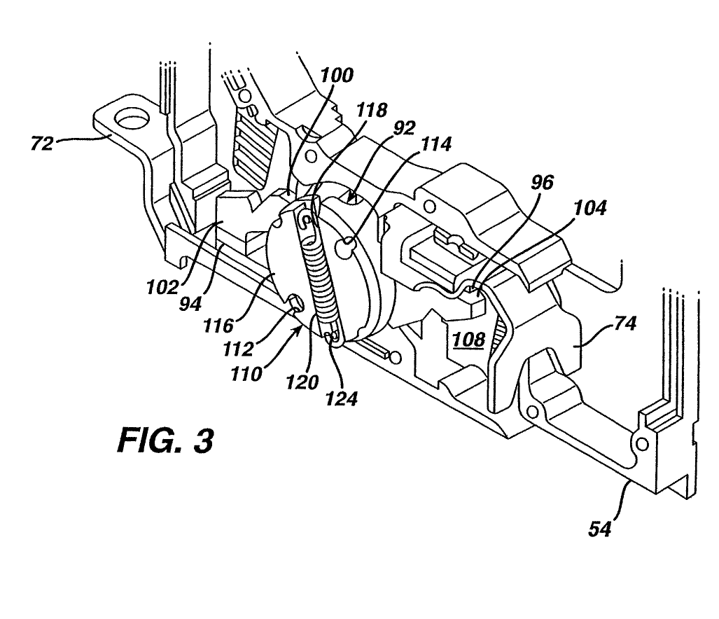

Referring now to FIG. 3, a partial view of the inside of a cassette similar to cassettes 58, 60, 62 is shown. Each cassette 58, 60, 62 includes a rotary contact assembly 92. Rotary contact assembly 92 is disposed intermediate to line side contact strap 72 and load side contact strap 74. Line side contact strap 72 and load side contact strap 74 are configured as U-shaped reverse loop conductor straps. Line side contact strap 72 includes a stationary contact 94 and load side contact strap 74 includes a stationary contact 96. Rotary contact assembly 92 further includes a movable contact arm 100 having a set of contacts 102 and 104 that mate with stationary contacts 94 and 96, respectively. Furthermore, a quantity of ablative material (not shown) is provided adjacent to stationary contacts 94, 96. The ablative material can be, for example, a nonelectrically conducting material such as a glass melamine or a glass polyester resin, or a cotton base fiber on the surface of a suitable resin such as a phenolic.

A pair of arc handling portions 106, 108 are disposed proximate to line side contact strap 72 and load side contact strap 74, respectively. Arc handling portions 106, 108 typically contain an arc chute configured to divert a gas flow of the ablative material (described further herein) out of cassette 58, 60, 62. Contact arm 100 is mounted within a rotor 110. A pair of openings 112, 114 are disposed proximate to the outer perimeter of rotor 110. Openings 112, 114 are configured to accept crossbar is 66, 68.

Rotor 110 includes a pair of opposing faces 116 (one of which is shown in FIG. 3) and is configured to have a set of slots 118 disposed centrally across each face 116. A contact spring 120 is disposed in each slot 118. Each contact spring 120 is arranged on a pair of spring pins 122, 124.

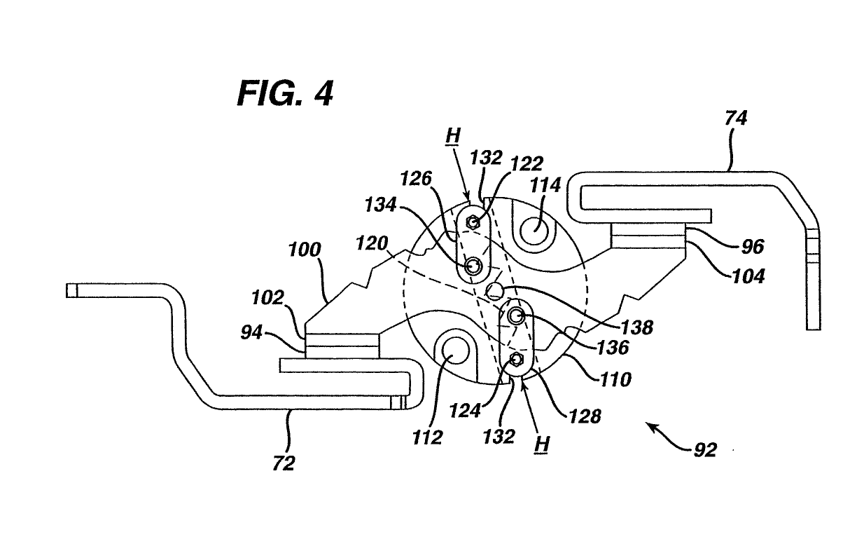

Referring now to FIG. 4, a side view of rotary contact assembly 92 is shown intermediate to line side contact strap 72 and load side contact strap 74. Spring pins 122, 124 are disposed on top of and at the bottom of, respectively, contact arm 100 via a pair of pivotal links 126 at the top and links 128 to the at the bottom. Spring pins 122, 124 are positioned within pin retainer slots 130, 132 formed in rotor 110 (intermediate to each face 116). Pivotal links 126,128 pivot upon pivot pins 134, 136, respectively.

Contact arm 100 and rotor 110 pivot about a common center 138. Center 138 typically is a cylindrical feature protruding from a central portion of contact arm 100 and is captured within rotor 110 to allow contact arm 100 to rotate separately from rotor 110.

Spring pins 122, 124 are positioned in line (co-linear) with center 138 so that the spring force, indicated by arrows H, exerted between spring pins 122, 124 is directed to intersect the axis of rotation of movable contact arm 100. The force H is transferred to movable contact arm 100 via spring pins 122, 124, links 126,128, and pivot pins 134,136. Pivot pins 134,136 are offset from the line created by spring pins 122, 124 and center 138. This offset allows the force H to rotate movable contact arm 100. The rotation of movable contact arm 100 urges movable contacts 102, 104 toward fixed contacts 94, 96, generating a contact pressure between movable contacts 102, 104 and fixed contacts 94, 96. Because the force H is centered through the rotational axis of movable contact arm 100, the force of movable contact 102 onto fixed contacts 64 is substantially equal to the force of movable contact 104 onto fixed contact 96.

During quiescent operation, contacts 102 and 104 are mated with stationary contacts 94 and 96 and contact arm 100 is in the “closed” position. That is, current flows from line side contact strap 72 to load side contact strap 74, through contact arm 100.

Reverse loop forces are created at the interface of fixed and movable contacts 94, 96, 102, 104, generally by current through the U-shaped line side contact strap 72 and/or load side contact strap 74. Furthermore, due to the non-uniform current flow through movable contact arm 100, constriction forces are created through contact arm 100 and at the interface of fixed and movable contact 94, 96, 102, 104. This causes movable contacts 102, 104 to be urged apart from fixed contacts 94, 96. The force caused by magnetic repulsion acts against the contact pressure created by the contact springs 120, which, in the absence of such magnetic repulsion, tend to maintain the fixed and movable contacts 94, 96, 102, 104 in a “closed” position.

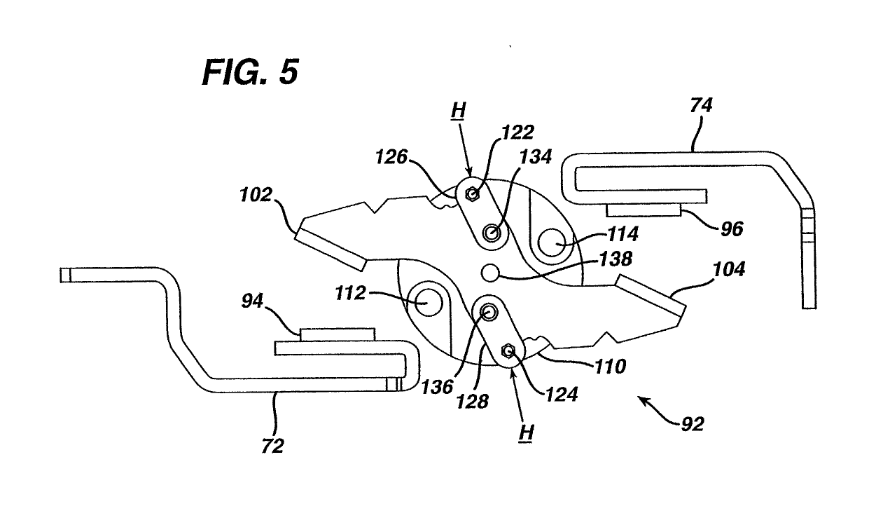

Referring now to FIG. 5, fixed and movable contacts 94, 96, 102, 104 are in an “open” position. The condition represented in FIG. 5 occurs, when, for example, the loop forces and/or constriction forces exceeds the contact pressure exerted by rotor structure 92, including springs 120, whereby contact arm 100 is urged in the clockwise direction about center 138, while rotor 10 remains stationary. The rotation of contact arm 100 moves pins 134 and 136 around center 138 and toward the line of force H created by springs 120. The motion of pins 134 and 136 is translated to spring pins 122 and 124 via links 126 and 128, causing spring pins 122 and 124 to translate within slots 130 and 132 towards the outer perimeter of rotor 110. The translation of spring pins 122 and 124 acts against the force of springs 120.

When pins 134, 136 and center 138 are aligned with the force H, the “overcenter” position is achieved. At this position, if the loop and constriction forces continue to overcome the force from spring 120, contact arm 100 will continue clockwise rotation about center 138 and remain “open”, as shown in FIG. 5,

At certain conditions e.g., “popping levels” or “withstand levels” (not shown), the loop and constrictive forces are high enough to overcome the contact pressure to separate the fixed and movable contacts 94, 96, 102, 104, but not high enough to bypass the “overcenter” position.

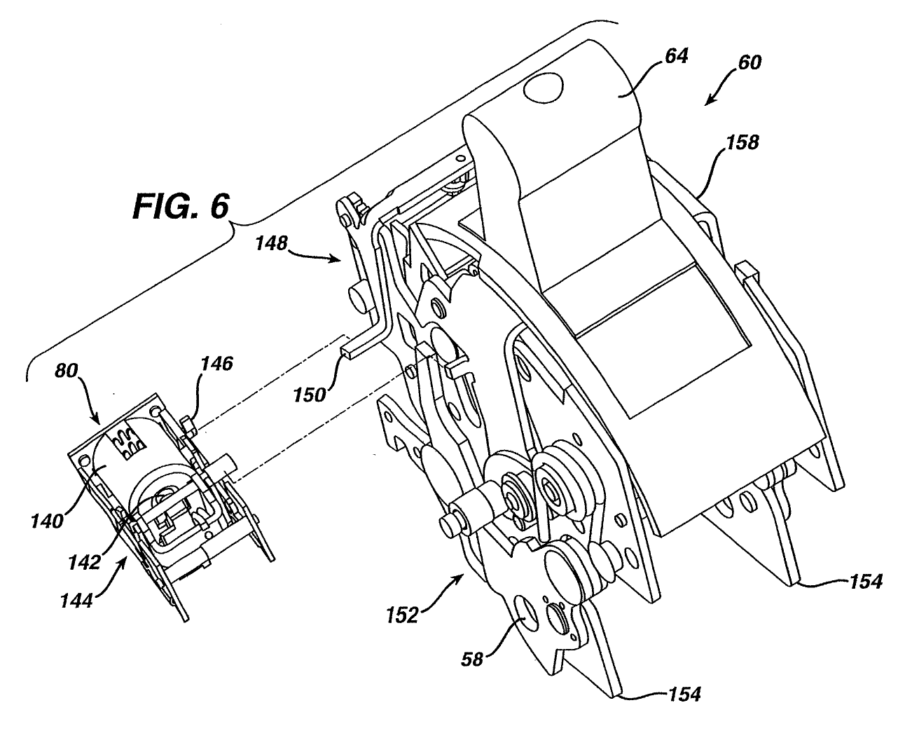

Referring now to FIG. 6, the interface between actuator 80 and operating mechanism 64 is shown. Operation of actuator 80 allows fixed and movable contacts 94, 96, 102, 104 to be separated even when the contact pressure exerted generally by contact springs 120 are not overcome by constriction forces and/or loop forces.

Actuator 80 includes a magnetic plunger assembly 140 that is coupled to, for example, circuitry within trip unit 78. Magnetic plunger assembly 140 includes a plunger 142 that moves from a retracted position to an extended position. An actuator linkage assembly 144 having an actuator trip tab 146 is positioned proximate to plunger 142.

Operating mechanism 64 includes a latch assembly 148, described in more detail herein. Latch assembly 148 includes a secondary latch trip tab 150 extending generally outwardly from operating mechanism 64 and positioned proximate to actuator trip tab 146 when circuit breaker 50 is assembled. Toggle handle 82 is interconnected with a mechanism linkage assembly 152, further described herein, which generally interfaces crossbar 66 through opening 70.

During quiescent operation, plunger 142 within actuator 80 is retracted. The fixed and movable contacts 94, 96, 102, 104 are closed such that current flows from line side contact strap 72 to load side contact strap 74.

Upon occurrence of a trip event (e.g., a short circuit, an overcurrent, or a ground fault), actuator 80 receives a trip signal generally outputted from circuitry within trip unit 78. The trip signal causes a magnetic flux within magnetic plunger assembly 140 to allow plunger motion from the retracted position to the extended position. When moved to the extended position, plunger 142 contacts a portion of actuator linkage assembly 144, which, in turn, causes displacement of actuator trip tab 146. The displacement of actuator trip tab 146 contacts secondary latch trip tab 150, which releases latch assembly 148 and causes mechanism linkage assembly 152 to translate crossbar 66. The translation of crossbar 66, in turn, causes rotary contact assembly 92, including contact arm 100, to rotate such that movable and fixed contacts 94, 96, 102, 104 become separated such that current is prevented from flowing from line side contact strap 72 to load side contact strap 74.

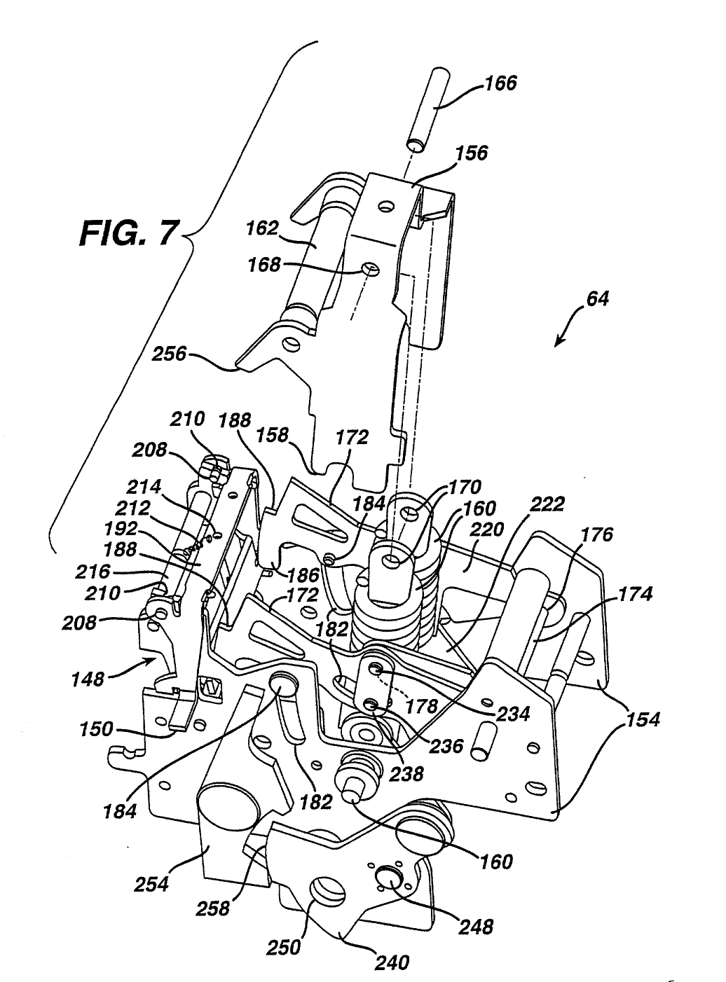

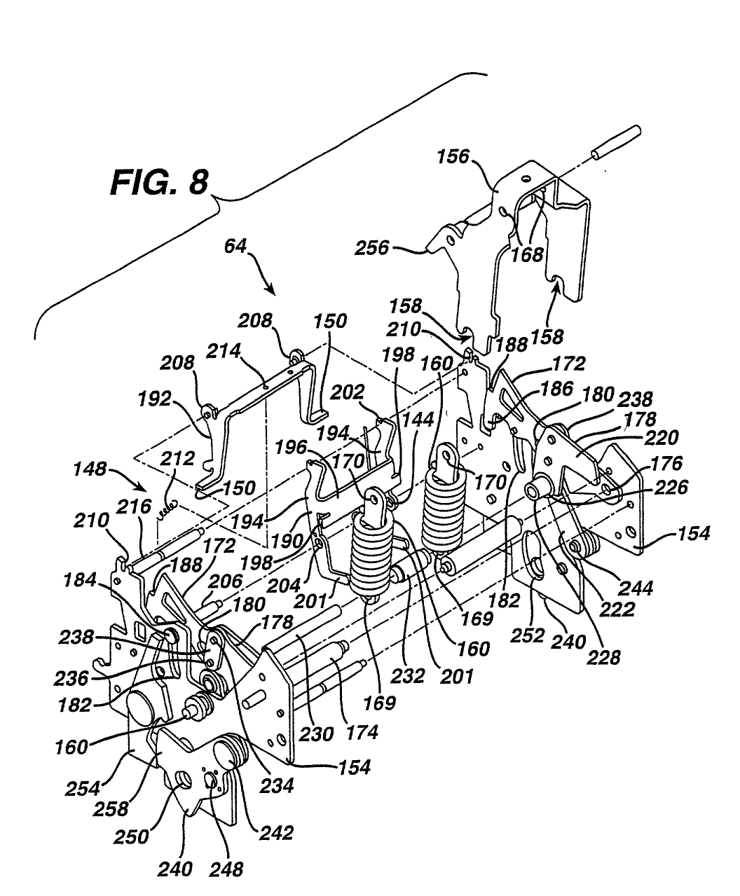

Referring now to FIGS. 7 and 8, certain components of operating mechanism 64 will now be detailed. Operating mechanism 64 has operating mechanism side frames 154 configured and positioned to straddle cassette 60.

Toggle handle 82 (not shown in FIGS. 7 and 8) is rigidly interconnected with a handle yoke 156. Handle yoke 156 includes U-shaped portions 158 that are rotatably positioned on a pair of pins 160 protruding outwardly from side frames 154. Handle-yoke 156 includes a roller pin 162 disposed intermediate to the sides of handle-yoke 156.

Handle yoke 156 is connected to a set of mechanism springs 164 by a spring anchor 166 generally supported within a pair of openings 168 in handle yoke 156 and arranged through a complementary set of openings 170 on the top portion of mechanism springs 164.

A pair of cradles 172 are disposed adjacent to side frames 154 and pivot on a pin 174 disposed through an opening 176 approximately at the end of each cradle 172. An opening 204 and an arcuate slot 180 are generally centrally disposed on cradles 172. Each cradle 172 is positioned generally under roller pin 162 and supported in an arcuate slot 182 on each side frame 154 by a rivet 184. Each cradle 172 includes an arm 186 that depends downwardly and a latch surface 188 generally disposed above arm 186.

Latch assembly 148 includes a primary latch 190 and a secondary latch 192. Primary latch 190 includes a pair of side portions 194 interconnected by a central portion 196. Central portion 196 includes a pair of extension portions 198 extending beyond side portions 194. Each side portions 194 includes an upper side portion 200 and a bent leg 201 at the lower portion thereof. Each upper side portion 200 includes a latch surface 202. An opening 204 is positioned on each side portion 194 so that primary latch 190 is rotatably disposed on a pin 206. Pin 206 has opposing ends secured to each side frame 154.

Secondary latch 192 is positioned to straddle side frames 154. Secondary latch 192 is pivotally mounted upon frames 154 via a set of pins 208 that are disposed in a complementary pair of notches 210 on each side frame 154. A spring 212 is disposed between an opening 214 on secondary latch 192 and a frame cross bar 216 disposed between frames 154. Secondary latch 192 includes a pair of latch surfaces 218, generally positioned proximate to latch surfaces 202 when primary latch 190 and secondary latch 192 are engaged, as described herein. Additionally, secondary latch 192 includes secondary latch trip tabs 150 that extend perpendicularly from operating mechanism 64.

Mechanism linkage assembly 152 includes a pair of upper links 220 and lower links 222. A bottom portion 224 of each upper link 220, generally U-shaped, and an opening 226 on each lower links 222, are commonly pivotable about an outer surface of a side tube 228. A side tube 228 is disposed on each side frame 154.

A pin 208 is disposed through a pair of openings 169 at the lower end of each mechanism spring 164, a central tube 232, and into each side tube 228. Therefore, each side tube 228 is a common pivot point for upper link 220, lower link 222 and mechanism springs 164.

Upper links 220 are interconnected with cradles 172 via a first rivet pin 234 disposed through opening 204 and a second rivet pin 236 disposed through arcuate slot 180. First and second rivet pins 234, 236 attached to a connector 238 at an opposing face of each cradle 172.

Lower link 222 is interconnected with a crank 240 via a pivotal rivet 242 disposed through an opening 244 in lower link 222 and an opening 246 in crank 240. Crank 240 is positioned on a crank center 248 and has an opening 250 where crossbar 66 passes through into arcuate slot 88 of cassette 58, 60 and 62 and a complementary set of arcuate slots 252 on each side frame 154.

A weld block lever 254 is also disposed on each side frame 154. Weld block lever 254 interacts with a blocking projection 256 of handle yoke 156, and with a cam portion 258 of crank 240 when a particular rotary contact assembly is fixed or welded in the closed position.

When latch assembly 148 is set, by urging handle yoke 156 in the counterclockwise direction as oriented in FIG. 7, primary latch surfaces 202 rests against secondary latch surfaces 218 and primary latch extension portions 198 rest against cradle latch surfaces 188. Crossbars 66, 68 assist in holding rotor 110 in the “closed” position, as seen in FIG. 4, because crank 240 is not caused to rotate by mechanism linkage assembly 152.

Also, urging handle yoke 156 in the counterclockwise direction translate a forced to mechanism springs 164, which drives pin 208 to the right so that a portion of upper link 220 and lower link 222 are in line. This causes crank 240 to rotate clockwise about crank center 248 thereby driving cross pin 66 to the upper end of arcuate slots 252 and rotating rotor 110 (including contact arm 100) clockwise about center 138 such that fixed and movable contacts 94, 96, 102, 104 are mated and current is allowed to flow through contact arm 100.

When latch assembly 148 is tripped, i.e. by actuator trip tab 146 contacting secondary latch trip tab 150, primary latch 190 is driven by mechanism springs 164 via the clockwise motion transmitted to cradles 172. Mechanism springs 164 also transmit a force via pin 208 to lower link 222, which causes crank 240 to rotate in the counter clockwise direction, thereby driving cross bar 66 and rotating rotors 110 within cassette 58, 60 and 62 so that contacts 102, 104 upon contact arm 100 are rapidly separated from stationary contacts 94, 96.

Automatic circuit protection against overload circuit conditions is provided by means of trip unit 78 located within mid cover 54. In certain circuit protection devices, trip unit 78 is an electronic trip unit. It is well known that trip unit 78 can be eliminated, or may comprise, e.g., a thermo magnetic trip unit, as will be further described. A rating plug can be included to allow the circuit interruption rating to be set by accessing the electronic trip unit without disassembling top cover 52 from mid cover 54. Electronic trip unit 78 generally receives an input from current transformer 76 and provides output to actuator 80 (i.e., a second type of interruption).

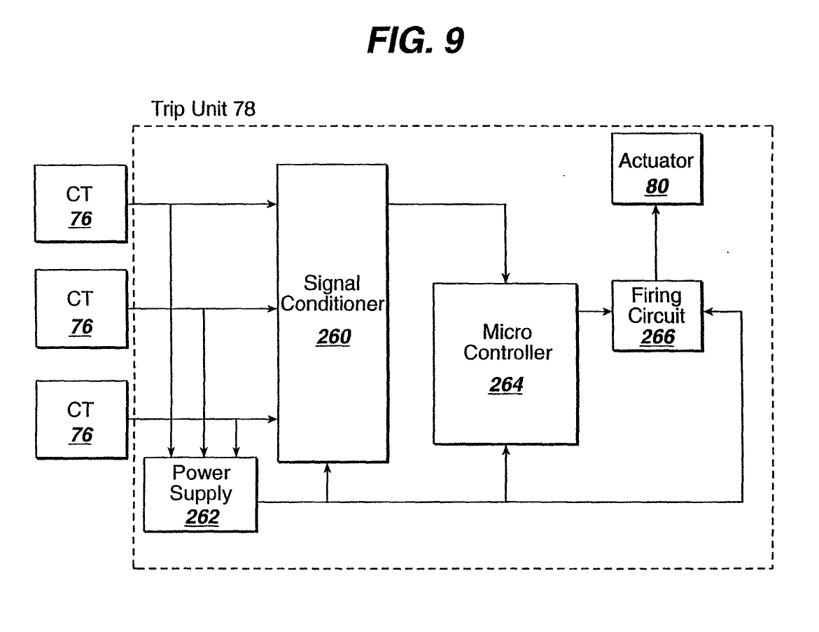

A block diagram of an exemplary electronic trip unit 78, including the input from each current transformer 76, is provided in FIG. 9. Current transformers 76 (one associated with each phase of current in a multi-phase system) provide inputs (in the form of a current) to trip unit 78 (indicated in FIG. 9 with dashed lines). In the example shown, trip unit 78 includes a signal conditioner 260, a power supply 262, a micro controller 264, a firing circuit 266, and an actuator 80.

The currents from current transformers 76 are coupled in parallel to power supply 262 and signal conditioner 260. Power supply 262 energizes signal conditioner 260, micro controller 264, and firing circuit 266. Signal conditioner 260 conditions current signal and feeds the current signal to micro controller 264. Generally, the signals fed to signal conditioner 260 are in analog form. These analog signals can be converted to digital signals with an analog-to-digital converter within signal processor 260, with an analog-to-digital converter within micro controller 264, or a combination of an analog-to-digital converter within signal processor 260 and an analog-to-digital converter within micro controller 264. Firing circuit 266 can be, for example, a low voltage power MOSFET. Control signals are sent from micro controller 264 to firing circuit 266. Upon a determination of a predetermined event, for example, an overcurrent condition, micro controller 264 provides a signal to firing circuit 266, which is energized by power supply 262 and outputs a trip signal to actuator 80. The trip signal to actuator 80 causes magnetic plunger assembly 140 to allow plunger motion from the retracted position to the extended position, which in turn causes plunger 142 to contact a portion of actuator linkage assembly 144 and displaces actuator trip tab 146. The displacement of actuator trip tab 146 contacts secondary latch trip tab 150, which releases latch assembly 148 and causes mechanism linkage assembly 152 to translate crossbars 66, 68 and separate movable and fixed contacts 94, 96, 102, 104 as described above.

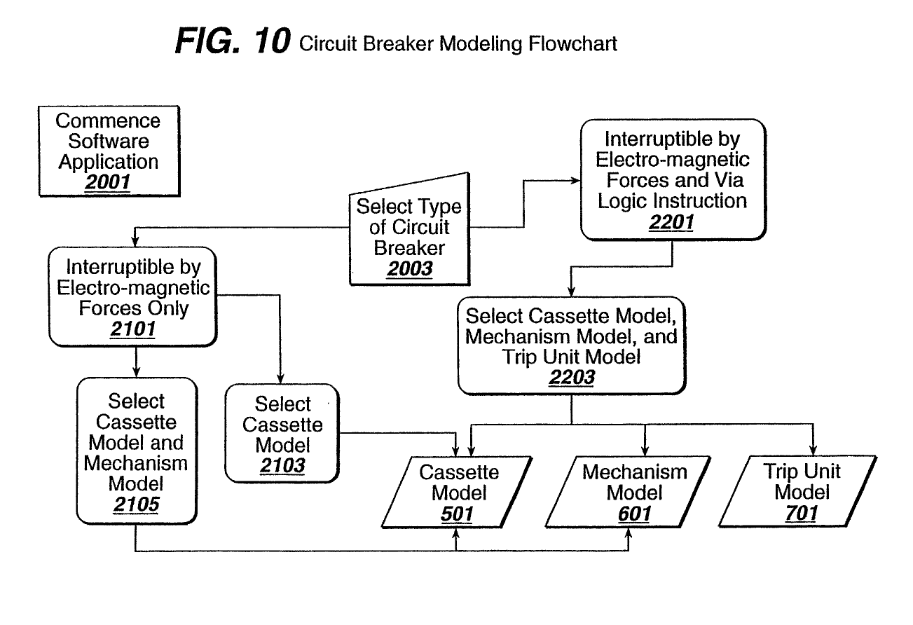

Referring now to FIG. 10, a flowchart outlining steps of modeling a circuit breaker is provided. The circuit breaker modeling described herein employs a software application capable of capturing behavioral and structural characteristics of circuit interrupters and circuit breakers. This is accomplished generally by providing an editor for inputting desired system properties. When certain groupings of properties (e.g., component level models, sub-assembly level models, interrupter models, load models, source models, distribution models, system models) are generated, they can be used, for example, with a simulator as described herein. Furthermore, the certain groupings can be stored in a database as models, which can subsequently be used.

In one embodiment, the resultant model is capable of merging with a system performance simulator. The simulator is capable of providing inputs to the model and generating the outputs, and, in certain embodiments, outputs of certain models are linked to other models. Additionally, parameters can be set representing system properties (e.g., maximum short circuit current, peak voltages, closing angle, power factor, line frequency). This is accomplished generally by incorporating a solver system within the software application. A model can be embedded within the software application and fed the inputs and linked to the solver, or can be embedded within the solver system. A model embedded in the software application can be within a database, or can be generated with an assembler or assembler system. The input can be presented from a direct user interface, or can be provided from a source such as a database, or model of a device (or output of a model of a device) that would typically provide input to the model (e.g., a source, load, distribution device of other protection device).

The particular software application employed for the modeling described herein is Saber®, including SaberDesigner®. It is, of course, understood that other suitable software applications capable of designing and integrating multiple engineering attributes (e.g., electrical, electronic, digital, logical, electromagnetic, magnetic, mechanical, thermal, fluid, and/or hydraulic) can be employed.

At block 2001, the software application is launched by the user. This can be achieved by opening the core software application, wherein the user subsequently selects a previously generated circuit breaker application, for example, from a schematic file. Alternatively, the circuit breaker application can be selected directly, wherein the core software application opens directly to the circuit breaker application.

The various components of the circuit breaker have different structural and behavioral aspects, including electrical, electronic, digital, logical, electromagnetic, magnetic, mechanical, thermal, fluid, and/or hydraulic. The aspects that must be modeled depend on the particular type of circuit breaker. Therefore, at block 2003, the user selects generally the type of circuit breaker to be modeled.

If, for example, only overcurrent conditions generating high loop and constriction forces at the contacts are to be protected, the user would so indicate and be directed to a block 2101. At block 2101, the user selects a circuit interrupter model including a cassette model at block 2103, or a cassette model and a mechanism model at block 2105. Where a cassette model alone is sufficient to model the breaker, a selection of a cassette model 501 is effectuated at block 2103. Where a cassette model and mechanism model are used to model the breaker, for example, if resetting action is to be modeled, or in the case of air breakers where the mechanism is a mass elastic unit, a selection of a cassette model 501 and a mechanism model 601 is effectuated at block 2105. The user selections for cassette model 501 or mechanism model 601, or for one or more components cassette model 501 or mechanism model 601, are made from a library or group of libraries of components as described herein.

When additional and/or supplemental circuit interrupter protection is modeled, the decision would be made at block 2003 to choose the circuit breaker interruptible by electromagnetic forces and upon occurrence of one or more predefined trip events, indicated at block 2201. Here, the user would select a cassette model, a trip unit model, and a mechanism model, indicated at block 2203. The cassette model employed is represented at block 501 (i.e., the same or different cassette model as selected according to blocks 2103 or 2105); the mechanism model employed is represented at block 601 (i.e., the same or different cassette model as selected according to block 2105); and, the trip unit model employed is represented at block 701.

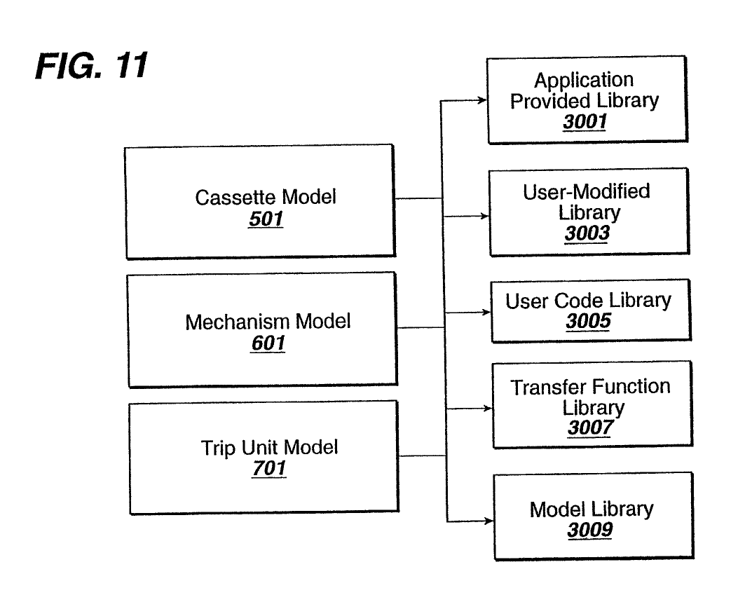

Referring now to FIG. 11, the selection of cassette models 501, mechanism models 601, or trip unit model 701 from various libraries is generally shown. The user can select models wholly from a model library 3009. Alternatively, the user can select various component or part models and assemble a model from those component or part models. These various component models are user generated, for example, with an editor provided by the application; selected from one or more libraries such as an application provided library (3001), a user-modified library (3003), a user code library (3005), a transfer function library (3007), or a model library (3009); or, both user generated and selected from one or more libraries. When a model has been created, that model can be saved in an appropriate library for future use.

As described herein, the models typically are mathematical representations. These mathematical representations are generally fed certain input variables and produce certain output variables. The variables can reflect tolerances, for example, by being in the format of a probabilistic distribution.

As described herein, the various models that can be generated include system models (e.g., of one or more circuit breakers associated with particular loads and power sources); circuit interrupter models; sub-assembly models (e.g., cassette models 501, mechanism models 601, and trip unit models 701); and, component models (i.e., the models used to generate the sub-assembly models or other component models). Any of the libraries 3001, 3003, 3005, 3007 or 3009 can include circuit interrupter models, sub-assembly models, and component models. In an embodiment described herein, library 3001 generally includes component models; libraries 3003, 3005 and 3007 generally includes sub-assembly models and component models; and library 3009 generally includes system models, circuit interrupter models, sub-assembly models and component models.

The application provided library 3001 represents a group of component models packaged with software application. For example, modeling software such as Saber® includes models of electronic devices (including transistors, MOSFETS, diodes and IGBTs ), mechanical devices (including mechanical stops, mechanical frictions, gears, cam followers, and springs), magnetic devices (including linear and non-linear cores, windings, and transformers), electromechanical devices (including relays, solenoids, and motors), and hydraulic devices (including valves and reservoirs).

The user modified library 3003 represents a library of sub-assembly models or component models selected from the application provided library 3001 (or a similar such library) and user modified to suit particular design or simulation needs. With Saber® modeling software, for example, a code language is provided (e.g., MAST® Hardware Description Language). Thus, the user can edit code (e.g., with an appropriate editor) for a particular library component model and the modified component model can be stored in the user modified library 3003. Alternatively, a component model selected from a library such as library 3001 can be graphically represented on the screen wherein certain behavioral and/or structural parameter variables are user inputted. Once a set of parameters has been entered, the tailored component model can be stored in the user modified library 3003.

User code library 3005 can include sub-assembly models and component models wherein the user has generated code for a sub-assembly model or a component model. Parts modeled and stored in user code library 3005 can be generated by, e.g., MAST® Hardware Description Language, VHDL (Verilog Hardware Description Language), VHSIC HDL (Very High Speed IC Hardware Description Language), Fortran, C, C++, Java, ASIC, or any appropriate code language that can be translated to be compatible with the software application employed. This user code library adds much flexibility to the types of parts or components that can be modeled. The user code library 3005 is particularly useful for storing models of digital implementations or algorithmic implementations within circuit interrupters, such as trip unit codes and other controller codes.

Transfer function library 3007 can include sub-assembly models and component models represented as transfer function. Generally, a transfer function is the relationship between the input and the output of a system or subsystem. The transfer function can be a code script and embedded as a separate model, it can be tied within other code, or it can be presented separately in the software application to tie various components together, or co-simulated by a separate solution software package linked to the primary solver. Models within transfer function library 3007 can include, for example, mathematical relationships or look up tables corresponding with data generated by FEA (finite element analysis) or CFD (computational fluid dynamics).

Model library 3009 can include stored system models, circuit interrupter models, sub-assembly models, or component models. When an individual sub-assembly model, circuit interrupter model, or system model is generated, that model may be stored in model library 3009 and later reused. The models stored within model library 3009 can be generated by code alone or in combination with one or more model parts from any library 3001, 3003, 3005 or 3007. Furthermore, a model within model library 3009 can be generated from another model within model library 3009.

Cassette model 501 can be selected as a sub-assembly model directly from one of libraries 3003, 3005, 3007 or 3009. Alternatively, cassette model 501 can be built using component models from one or more libraries 3001, 3003, 3005, 3007 or 3009. Mechanism model 601 and trip unit model 701 can likewise be subassembly models or built from component models.

In the case where a system model is desired, for example, to analyze a selective system, one or more circuit interrupter models can be selected directly from model library 3009.

Once a particular system model, circuit interrupter model, subassembly model, or component model has been generated, that model can be included within the appropriate library. One or more component models selected from one or more libraries can generate a sub-assembly model. The generated sub-assembly model can then be stored in model library 3009. A circuit interrupter model can also be generated by one or more sub-assembly models selected from one or more libraries and the generated model can then be stored in model library 3009. Additionally, a system model can also be generated by one or more circuit interrupter models selected generally from model library 3009 and the generated system model can then be stored in model library 3009.

Furthermore, individual component models can be stored in the model library 3009. For example, as described above, a library element from library 3001 can be modified or set and stored in user modified library 3003. This element can also be stored in library 3009 if appropriate. Storage in library 3009 may be desirable to streamline the user selection process by storing frequently used elements therein. Likewise, user generated code can be stored in user code library 3005 or model library 3009, and transfer functions can be stored in transfer functions library 3007 or model library 3009.

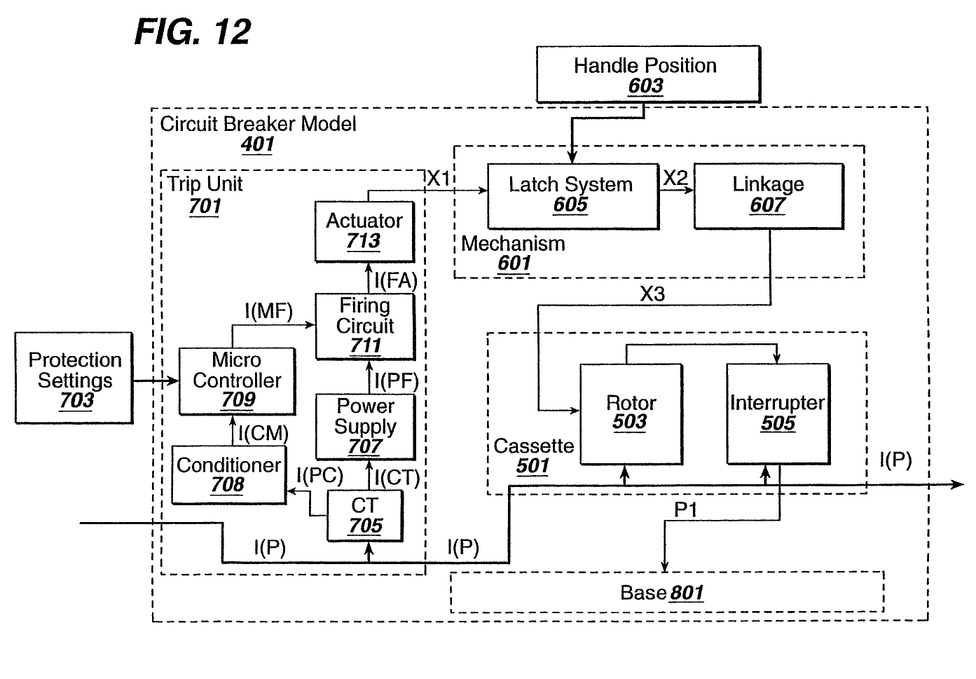

A component block diagram of a circuit breaker is shown in FIG. 12. This block diagram will be used to describe an embodiment of a circuit breaker model 401. Major components are represented by cassette model 501, mechanism model 601, and trip unit model 701. Also represented is a base block 801 which represents the physical geometries of the circuit breaker housing and cassette housing in certain embodiments. The component models that comprise trip unit model 701 include a current transformer model 705, a power supply model 707, a conditioning model 708, a micro controller model 709, a firing circuit model 711, and an actuator model 713. Also, a protection settings block 703 is coupled to micro controller model 709 serving to provide, for example, external settings. The component models that comprise mechanism model 601 include a latch assembly model 605 and a linkage model 607. The component models that comprise cassette model 501 comprise a rotor model 503 and an interrupter model 505.

The modeling approach described herein captures various aspects of the circuit breaker. The trip unit model 701 captures the electrical, electronic, and electromechanical aspects, including, for example, current transformer 76, electronic trip unit 78 and actuator 80 described above. The cassette model 501 captures the electrical, electromagnetic, thermal, gas, and electro-dynamic aspects of, for example, cassettes 58, 60 and 62 and their components. The mechanism model 601 captures the mechanical dynamics of, for example, operating mechanism 64. The base block 801 captures the structural aspects, of for example, base 56 and mid cover 54. While certain components and subcomponents of a circuit breaker are shown, the modeling described and implemented herein functions effectively with the implementation of fewer, additional or different components or subcomponents.

Circuit interrupter models have been implemented wherein the trip unit model 701 was eliminated or substituted. Where the electronic trip unit model 701 was eliminated, the model is of a circuit interrupter whereby current flow through movable contact arm 100 is interrupted by way of electromagnetic forces that blow open the contacts (i.e., loop forces and constriction forces strong enough to overcome the contact pressure generally exerted by contact springs 120). This modeling selection is generally shown in FIG. 10 at blocks 2101, 2103 and 2105. Alternatively, current transformer 76 and electronic trip unit 78 and can be substituted with another sensing and tripping means, such as a thermal-magnetic unit. A thermal-magnetic unit employs a thermal element such as a bimetal to sense the current and trip in the case of an overload current and a magnetic element to provide a force to trip the circuit interrupter in the case of a short circuit condition.

In one embodiment, trip unit model 701 represents an electronic trip unit such as trip unit 78. A variable I(P) representative of a primary current is fed through trip unit model 701 and cassette model 501. Each component model is linked together generally with pertinent variables.

Trip unit model 701 is linked to mechanism model 601 by a displacement variable X1 (e.g., transmitting a force from actuator trip tab 146 to secondary latch trip tab 150). The mechanism model 601 is linked to the cassette model 501 by a displacement variable X3 (e.g., transmitting a force via crossbars 66, 68 to rotor 110). The cassette model 501 is linked to the base model 801 by a pressure variable P1 (e.g., the pressure exerted by the fluid flow from the arc handling portions 106, 108).

Parameter settings for the electronic trip unit model 701 are also indicated and are controllable at protection setting block 703. Protection setting block 703 can represent, for example, setting provided by a rating plug, switch, or internal setting within micro controller 264 of trip unit 78. Additionally, a handle position block 603 is shown relative to the mechanism model 601, which represents the state of the mechanism, for example, the position of toggle handle 82.

Each sub-assembly model is generated with one or more components selected from one or more libraries 3001, 3003, 3005, 3007 and 3009, as described above and indicated at FIG. 11. The modeling choice for each individual element depends on a variety of factors including, but not limited to, desired modeling accuracy level, complexity of the selected element, or availability of modeling choices for a particular element. Component models comprise either a single component model; a combination of similar types of component models; or, a combination of different types of component models.

Upon modeling of an individual sub-assembly (e.g., the cassette, the electronic trip unit, or the mechanism), that sub-assembly model may be stored in, e.g., model library 3009 and reused to rebuild a model of a similar circuit breaker, or to build a model of a different circuit breaker using that sub-assembly model, or variation of that sub-assembly model.

In the circuit interrupter model illustrated, the trip unit model 701 is the control block within a circuit breaker. The simulated current I(P) is fed to trip unit model 701 via current transformer model 705. Current transformer model 705 accounts for aspects including electrical and magnetic aspects of current transformers. A variable I(CT) is a simulated current from current transformer model 705 to power supply model 707, representing a current value provided from one or more current transformers (such as current transformers 76) to a power supply (such as power supply 262).

Power supply model 707 models a power supply within the electronic trip unit, e.g., power supply 262 within trip unit 78, and accounts for aspects including electrical aspects of power supplies. Power supply model 707 generally receives the simulated current value I(CT) from current transformer model 705 and produces a simulated current value as a variable I(PF), for example, representing the energizing power lead from power supply 262 to firing circuit 266. Additionally, a variable I(PC) is a simulated current from power supply model 707 to conditioner model 708, representing current value provided from a power supply to a signal conditioner (such as signal conditioner 260).

Conditioner model 708 generally represents a signal conditioner (e.g., signal conditioner 260), and accounts for aspects including electrical aspects of signal conditioners. A variable I(CM) is a simulated current value from conditioner model 708 to micro controller model 709, representing a conditioned current signal fed from a signal conditioner to a micro controller (such as the signal conditioner 260 feeding a signal to micro controller 264).

Micro controller model 709 generally represents a micro controller (e.g., micro controller 266) and associated electronics (e.g., signal conditioner 260 and A/D converter 264) Micro controller model 709 accounts for aspects including electronic aspects of a trip unit (such as trip unit 78). Micro controller model 709 simulates the processing of I(CM) fed from current transformer model 705.

A simulated signal current, for example, representing a signal current from micro controller 264 to firing circuit, is outputted as a variable I(MF) by micro controller model 709 to firing circuit model 711 generally under attainment of modeled protection settings represented in block 703. Firing circuit model 711, which accounts for aspects including electrical aspects of a trip unit (such as trip unit 78), outputs a variable I(FA) to actuator model 713. Actuator model 713 represents an actuator (e.g., actuator 80) and accounts for aspects including electromechanical aspects of a trip unit (such as trip unit 78).

Displacement variable X1 is outputted from actuator model 713 generally to mechanism model 601. Specifically, X1 is coupled to a latch system model 605 (e.g., representing latch assembly 148) within mechanism model 601. Latch model 605 outputs another displacement variable X2 to a linkage model 607 (e.g., representing the various linkages within operating mechanism 64) within mechanism model 601. Displacement variable X3 is outputted from linkage model 607 generally to cassette model 501, and specifically to rotor model 503. It should be noted that the representation of displacement variable X2 can be eliminated, for example, when mechanism model is simplified and does not include a separate latch model 605 and linkage model 607.

The mechanism represented by mechanism model 601 generally includes a handle, a latch system, a mechanism spring, and a series of links that interface the rotor assembly. As shown in FIG. 12, the latch system model 605 is tied to displacement variable X1 from trip unit model 701, and outputs a displacement variable X2 within mechanism model 601 to linkage model 607, which models the linkage interfacing one or more rotors.

Where link and spring behavior modeling is not necessary, a transfer function may be employed. The transfer function generally provides the mechanism torque as a function of the angular position of the rotor. The torque to angle data can be generated using a two-dimensional modeling tool, and is presented in the form of a look-up table. The mechanism is activated through the actuator, represented by actuator model 701.

Alternatively, a two-dimensional or a three-dimensional modeling tool that will mimic the behavior of the mechanical aspects of the circuit breaker can be employed. Depending on the level of mechanism detail required, individual elements such as links and springs can be connected in a fashion such that the overall model mimics the mechanism behavior. An approach for modeling the mechanical components in detail, exposing each component and component properties as a single simulation element, rather than a lumped transfer function, will now be described.

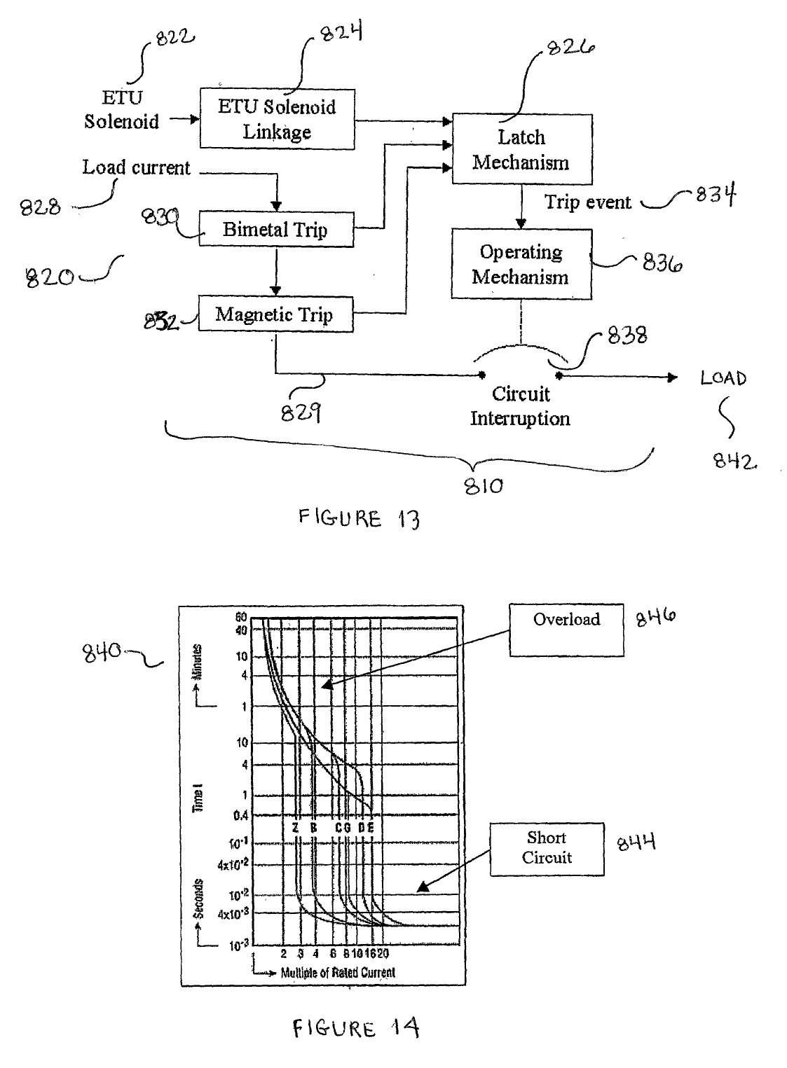

Referring now to FIG. 13, a block diagram 820 of typical circuit breaker functions within a circuit breaker 810 is outlined. The mechanical components of a circuit breaker 810 may be divided into hierarchical models, logically broken down by function. There are two main functions of a typical circuit breaker 810: trip units and operating mechanisms. Each of these two main functions may be further divided into specific trip functions and mechanisms as outlined in FIG. 13. While a circuit breaker 810 having specific components is described, it should be understood that circuit breakers having more, less, or different components may also be advantageously modeled using the modeling system of this invention. For example, the circuit breaker 50 described above in FIGS. 1-9 employed the electronic trip unit 78, without a bimetal or magnetic trip. In such a circuit breaker 50, the modeling tool could still be utilized to model the ETU 78 as well as the mechanical components of the operating mechanism 64.

FIG. 13 shows how an ETU solenoid 822 is linked through linkage 824 to latch mechanism 826. Load current 828 is received by bimetal trip unit 830, which may activate the latch mechanism 826, as will be described. The load current 828 also passes through the magnetic trip unit 832, which may also activate the latch mechanism 826, as will be described. Once the latch mechanism 826 is activated as a result of a trip event 834, an operating mechanism 836 operates to separate circuit breaker contacts 838 creating a circuit interruption.

Each block within block diagram 820 represents a model which can be isolated for individual design and testing or that can be integrated into future models. The mechanical system is ultimately connected to an electrical model of the electronic trip unit, e.g. 78, and to the load current 828. The result is an overall model of the electro-magneto-mechanical behavior for the circuit breaker 810.

Trip units, e.g. 830, 832, and 78 are used to monitor the load current 828 for faults and react in a way to cause a circuit breaker 810 to open the circuit 829 and interrupt current flow to the load 842. Three different trip units 830, 832, and 78 provide different aspects of the trip-time curve 840. An example of a trip-time curve 840 is shown in FIG. 14. Each trip unit outputs a torque that is summed and applied to the latch. Sufficient torque causes the latch to trip.

The magnetic trip unit 832 is activated during a short circuit event 844. The high current causes the magnetic trip unit 832 to close by magnetic force and trip the breaker 810. The reaction time of trip unit 832 is quick and prevents a large amount of uncontrolled energy from passing through the breaker 810.

The bimetal trip unit 830 operates in the overload area 846 of the trip-time curve 840. Load current 828 flowing in the bimetal trip unit 830 causes a deflection of a bimetal strip 852, as shown in FIGS. 15 and 16. The strip 852 deflects slowly, compared to the magnetic trip unit time. The trip unit 830 is primarily activated when equipment or wiring degrades, causing an increase in load, or in the case of excessive devices attached to one circuit 829.

A ground fault circuit interrupter (“GFCI”) also contains an electronic trip unit 78 (“ETU”) that is designed to trip the circuit breaker 810 if some load current 828 is diverted from the load conductor to earth ground. In this fault situation, a hazardous voltage may appear on exposed surfaces of equipment presenting a shock hazard. The ETU 78 uses electronics, a solenoid 822, and a mechanical linkage 824 to trip the breaker 810 when a fault current is sensed.

Each of the magnetic trip unit 832, bimetal trip unit 830, and ETU 78 makes use of a well-defined input and outputs a trip command to the mechanism 826 via a torque variable. The outputs from each trip unit 830, 832, 78 can be summed and applied to the latch mechanism 826.

A model for the bimetal trip unit 830 captures the resistive heating behavior of the bimetal strip 852. One example of a bimetal strip 852 is shown in FIG. 16, with the location of the bimetal strip 852 within the circuit breaker assembly 850 shown in FIG. 15. The heating losses to the ambient and through conduction are modeled as well. The temperature of the strip 852 is stored in a thermal capacitance and linked to a transfer function to determine the bimetal force per Texas Instrument Publication, “Thermostat Metals Designer's Guide”, #MMFB006A. If the bimetal 852 were to be constrained in deflection, a force is produced. This temperature-dependent force is applied to the bimetal spring rate (as a cantilever beam). In no other connections are made to this force output, the pure deflection of the bimetal 852 can be simulated. In the GFCI circuit breaker simulation, this force is converted to a rotational torque and applied to the latch mechanism 826. Sufficient deflection and force applied will cause the circuit breaker 810 to trip. Thus, the inputs to a bimetal trip model are the load current through GFCI, ambient temperature, and calibration temperature and the output is the torque on the latch.

As shown in FIG. 15, the end 855 of the bimetal strip 852 with the notch 851 and protrusion 853 is free to deflect and the protrusion 853 pushes on the latch 860 when tripping the circuit breaker 810. The opposite end 857 is secured to a support element and is considered fixed. The bimetal strip 852 is modeled as a cantilever beam with one fixed end 857 and one free end 855. The free end 855 is visible within FIG. 15.

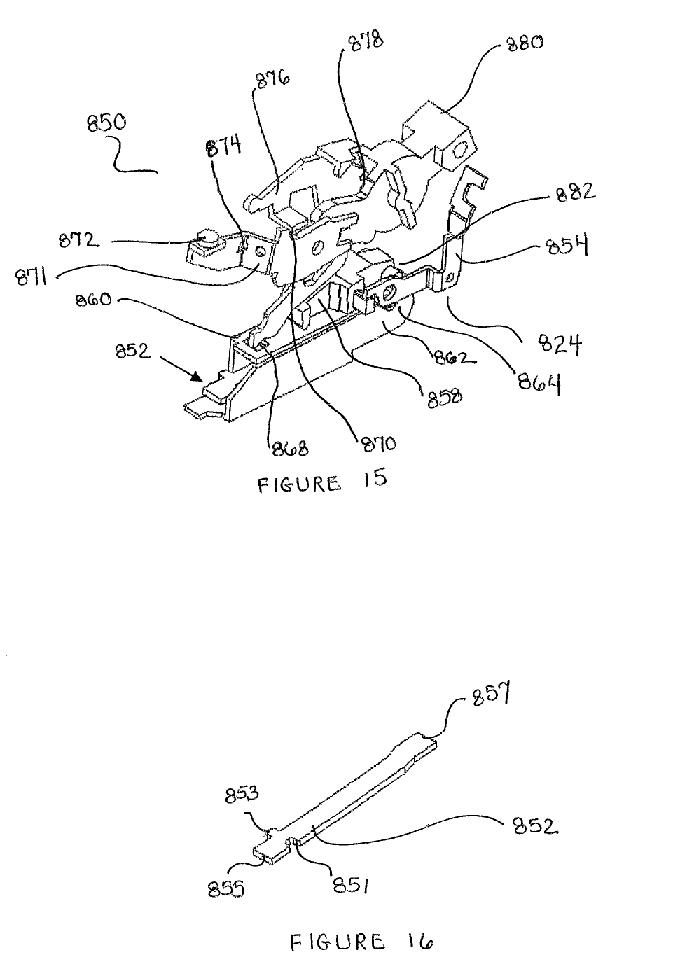

FIG. 17 and the other models within this invention are depicted as screen shots, or screen captures. FIG. 34 depicts a screen shot of what the property editor looks like along with the rest of SABER®.

The modeling system for the bimetal trip unit 830 may comprise three logical models: bimetal heating 904, bimetal_deflection 906, and the overall bimetal_trip model 902. All aspects of the mechanical model may be divided in a similar manner to increase the hierarchical structure allowing for modularity, reuse, and low-level testing or design.

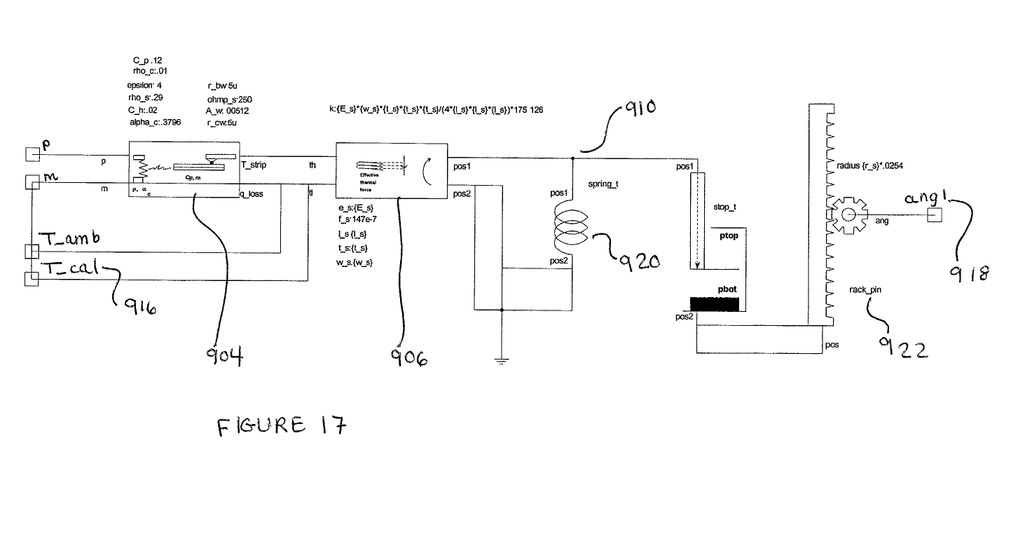

Referring to FIG. 17, the bimetal_trip model 902 determines the temperature 908 of the bimetal strip 852 and calculates the deflection and force 910 exerted by the strip 852. The bimetal_heating model 904, as further shown in FIG. 18, applies the heat generated from I²R losses to the mass of the strip 852 to generate a temperature rise. The heat losses are through pin q_loss 912 and the strip temperature is output on T_strip 914. Thus, the input to the bimetal heating model is the load current through GFCI and ambient temperature and the output is the temperature of the bimetal and heat lost to ambient.

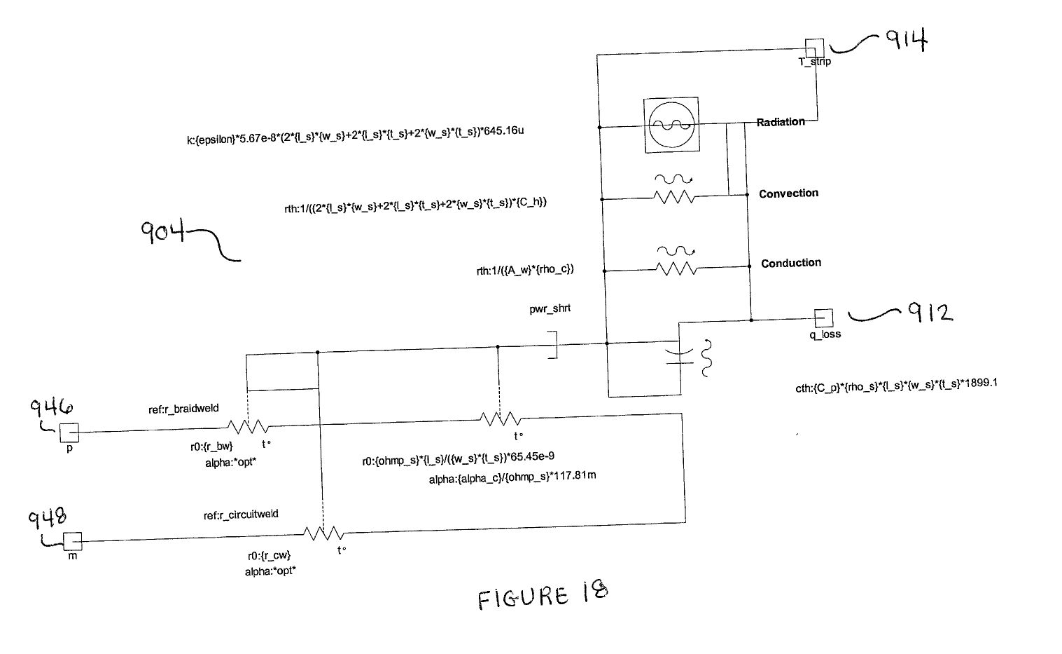

With some temperature rise above T_cal 916, the strip 852 will deflect some distance depending on the external forces exerted on the strip 852. The bimetal_deflection model 906, as further shown in FIG. 19, calculates the force of the bimetal 852 and this force is applied to the spring rate of the bimetal strip 852. The spring 920, along with the external torques seen at the output pin, ang1 918, combine to determine the total bimetal deflection 910.

A translational stop models the gap present between the bimetal strip 852 and the latch 860 at the calibration temperature, T_cal 916. The rack and pinion 922 provides conversion from translational bimetal strip deflection 910 to torque using the moment arm of the latch 860 referenced at the latch pivot. Thus, the input to the bimetal deflection model is the bimetal temperature and the calibration temperature and the output is force if the strip is constrained.

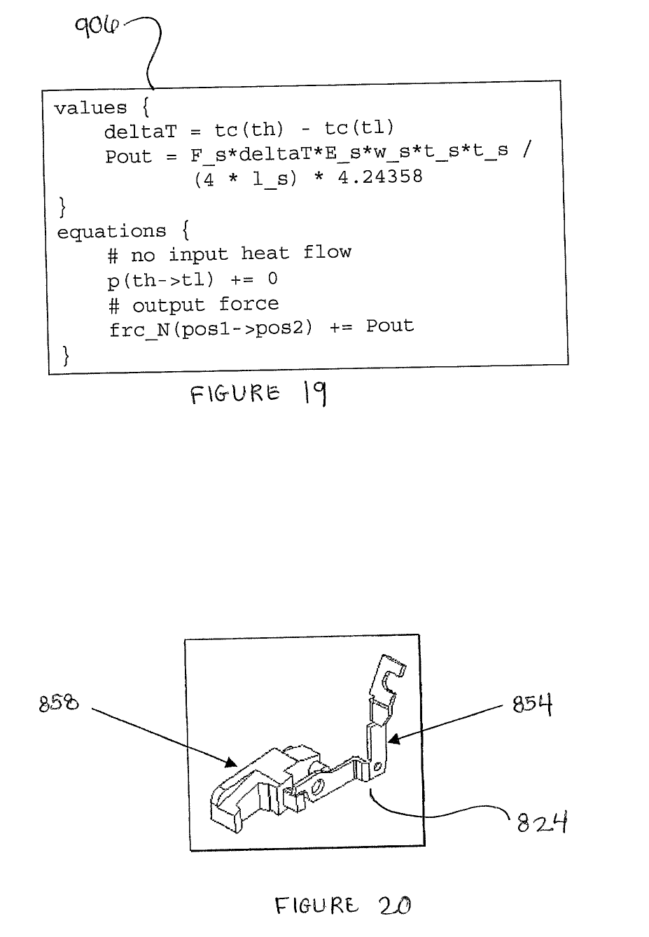

Referring to FIGS. 15 and 20, the electronic trip unit linkage 824 transmits force from the electrically controlled solenoid 822 to the latch 860 during a trip event 834. There are many conversions of translational motion and rotational motion amongst various moment arms through the linkage 824. Also present is significant backlash modeled as translational stops. The solenoid lever 854 and latch lever 858 can be seen in FIG. 20, and the positioning of the linkage 824 can be seen in FIG. 15. Thus, the input into the solenoid mechanism model is the force from the solenoid plunger, and the output is torque on the latch.

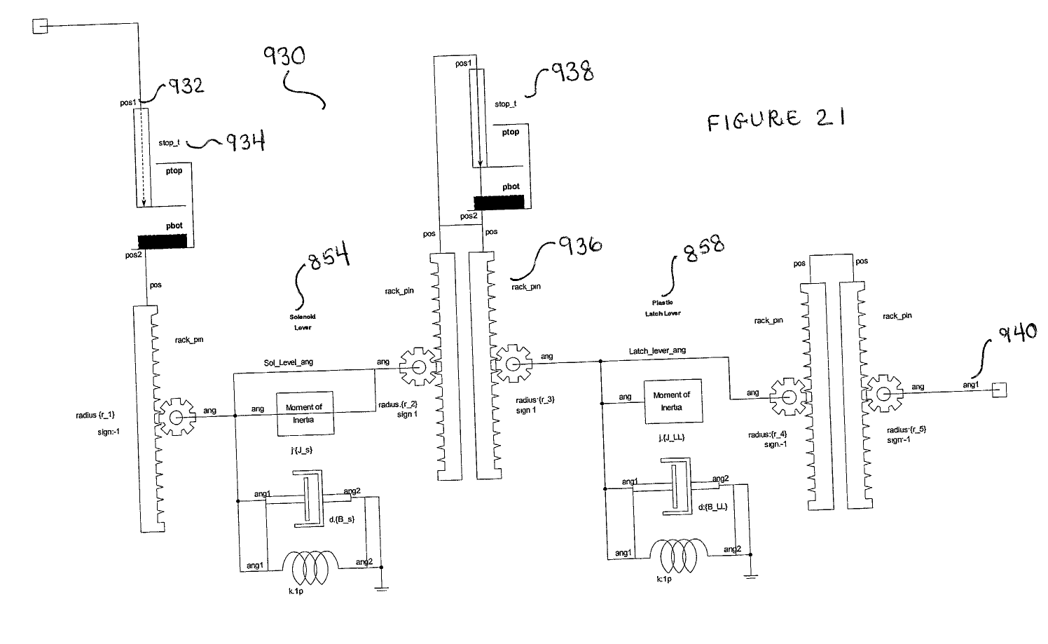

Turning now to FIG. 21, the sol_mech model 930 takes the solenoid force as the through variable on pin “pos1” 932. The components in the linkage are purely rotational and are modeled using angular inertias and damping elements. Interactions between the components are approximated with translational motion, as the angle of rotation is very small. The backlash is modeled with a translational stop 934 and is then converted to a torque via a moment arm of the solenoid lever 854. This torque acts on the solenoid lever 854 inertia and damping. The middle rack and pinion elements 936 and translational stop 938 model the interface between the solenoid lever 854 and latch lever 858. Output of torque on the latch 860 is a through variable on pin “ang1” 940.

Referring to FIG. 15, the magnetic trip unit 832 makes use of two elements in the assembly 850: the latch 860 and the magnet 862. The magnet 862 is not a permanent magnet, rather it is a ferrous material that serves as a flux path in conjunction with the latch 860. Current flowing through the bimetal strip 852 induces a magnetic flux in both the latch 860 and the magnet 862. If the current is high enough, the flux flowing through the air gaps between the latch 860 and magnet 862 will generate sufficient force to close the gap and trip the circuit breaker 810.

The latch 860 and magnet 862 pivot together on the right side of FIG. 15 at pivot 864. In reality, the magnet 862 is free to rotate counterclockwise, but this motion is not needed and the magnet 862 is considered fixed.

The magnet trip model 942, referring to FIG. 22, uses the load current 828 on pins “p” 946 and “m” 948 to excite a winding 950 that generates a flux in the magnetic circuit. Because of non-linearities, the air gaps 952, 954 are divided into three sections 956, 958, 960, each of equal physical distance along the gap. For each section 956, 958, 960, an equivalent gap and the position of the equivalence is calculated. The summation of each gap force acting through a moment arm (rack and pinion elements 962) is summed and output to the latch 860. Sufficient force from the air gap 952, 954 will close the latch 860 to the magnet 862 and exert torque to the latch 860 causing a trip 834. Thus, the input to the magnetic trip model is the load current through GFCI and the output is the torque on the latch.

Referring again to FIG. 15, ultimate contact separation is accomplished with the operating mechanism 836 that is controlled by the handle 880 and latch 860. A contact-cradle spring (not shown) may be installed in between points 874 and 878 for connecting the contact 872 and cradle 876. A preload spring (not shown) is installed under the handle at location 882 and exerts a downward force on the latch 860. This spring force resists the torques applied from the trip units 830, 832, 78 and ensures the latch 860 remains in place during normal operation.

When a trip event 834 is applied (as a torque) to the latch 860, the latch 860 rotates counterclockwise, releasing the cradle 876 at Point 868. Free to move the spring-loaded cradle 876 quickly rotates clockwise and begins to push the contact 872 open at Point 870. The spring continues to provide complete contact separation.

As part of the modeling system, the mechanical elements are split into three significant modules: the latch mechanism 826, operating mechanism 836, and spring coupling. The spring coupling module is contained within the operating mechanism 836.

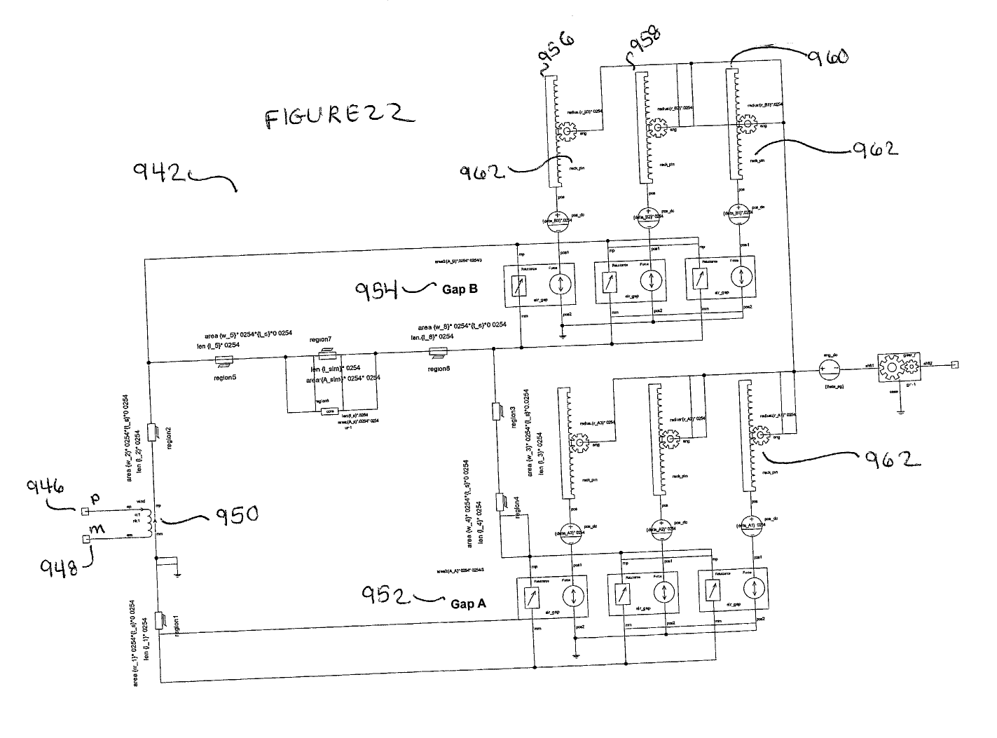

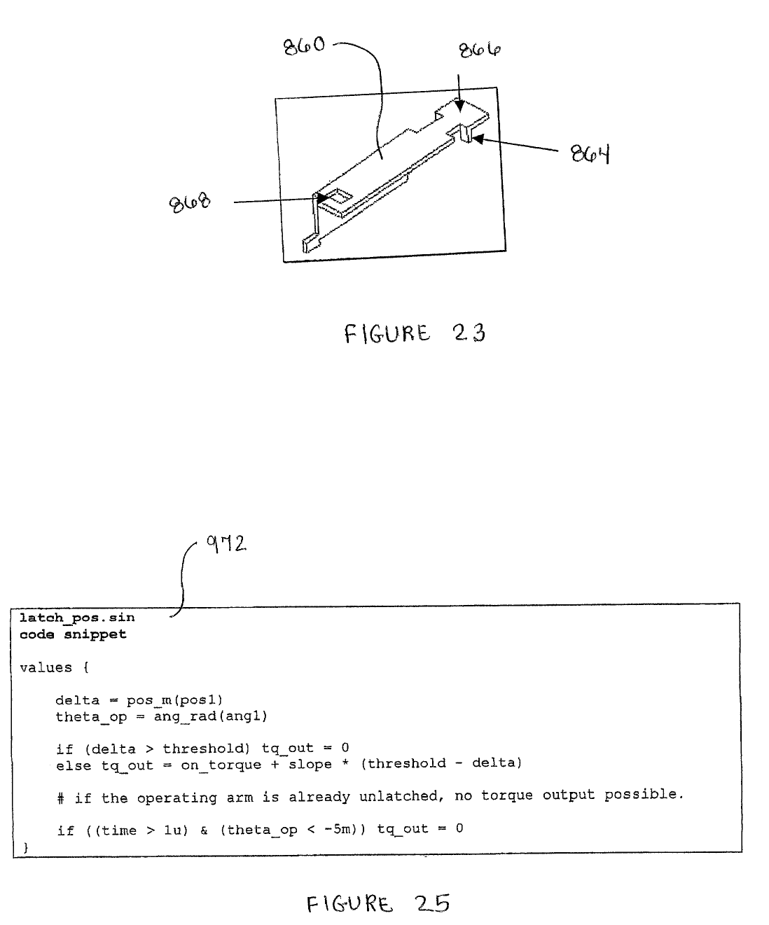

The latch 860 is acted upon by the trip units 830, 832, 78. The summed torque from the trip units 830, 832, 78 acts to pull the latch 860 closed to the magnet 862 through pivot 864 as shown in FIG. 23. When the latch 860 is closed, the cradle 876 is free to move by the spring energy stored in the contact-cradle spring. The preload spring (not shown) pushes downward on the latch 860 as shown by arrow 866 to maintain proper position during normal operation.

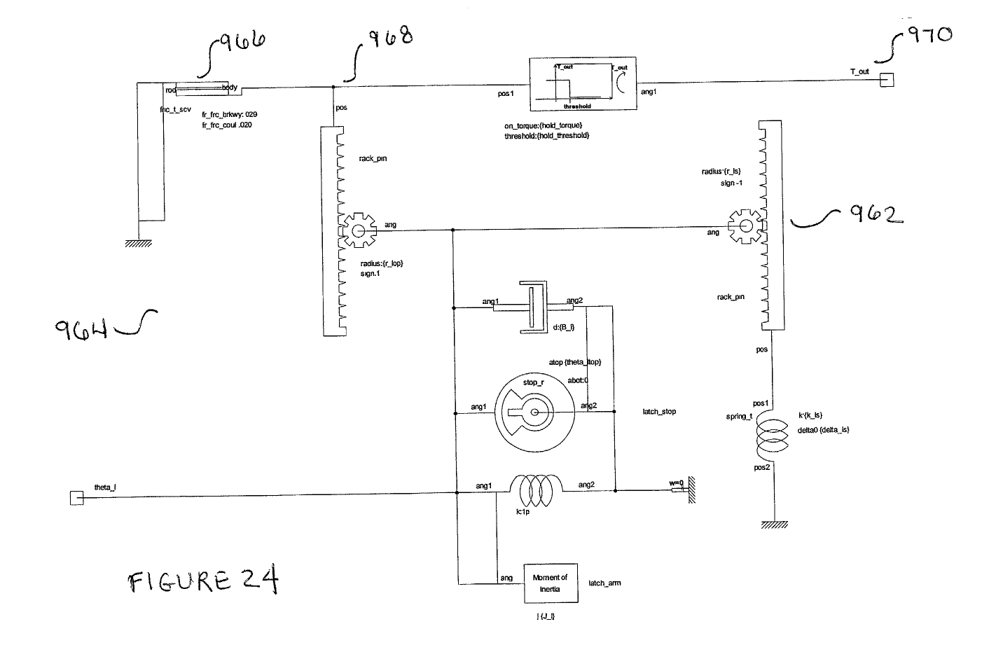

Referring to FIG. 24, the latch_mech model 964 is modeled using an angular inertia and a damping factor. Two rack and pinion elements 962 provide the translational position for the preload spring compression and the motion at Point 868. A friction element 966 is placed from the Point 868 motion (latch_vert 968 in FIG. 24) to model the static and kinetic properties of the cradle 876 and latch 860 interface. Thus, the inputs to the latch mechanism model are the torques from the trip units and the output is the torque to hold the cradle in “on” position. The torque is removed to allow trip.

The output pin T_out 970 is a direct connection to the output of the latch_pos model 972. Referring to FIG. 25, the latch_pos model 972 performs a thresholding function such that a torque is applied to the cradle 876 when the latch 860 is not tripped. A tripped condition is considered when the latch position (at latch_vert 968, Point 868), exceeds the threshold parameter. The torque output is opposite and greater than the torque on the cradle 876 by the contact-cradle spring. The net torque holds the cradle 876 against a hard stop until the latch 860 is tripped. With the trip, the holding torque is removed allowing the cradle 876 to move. The cradle 876 is held within the cutout at point 868 allowing the latch 860 to hold the cradle 876 in a position that holds the contact 872 closed. When the latch 860 opens, the cradle 876 is released, thus opening the contact 872. Thus, the input to the latch trip function model is the translational position of the latch and the output is the torque to hold cradle in an “on” position. With sufficient latch movement, holding torque is zero.

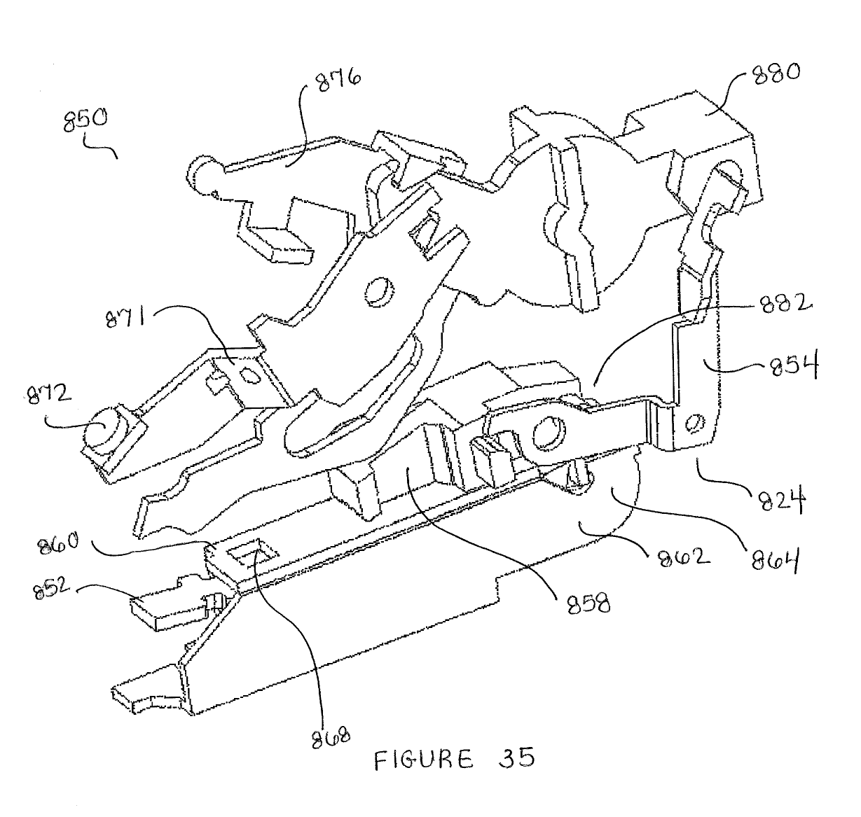

The operating mechanism 836 starts with the cradle 876. The cradle 876 is held in place by the latch holding torque. When the latch 860 removes the torque, the cradle 876 swings to the tripped position because of the spring coupling (the spring connecting points 874 and 878, as will be further described) to the contact 872. The contact 872 is held closed, as shown in FIG. 15, by the spring coupling before the trip event 834. After a trip 834, the cradle 876 pushes the contact 872 open via physical interference. In the tripped position, as shown in FIG. 35, the cradle 876 pulls the contact 872 open by the spring coupling.

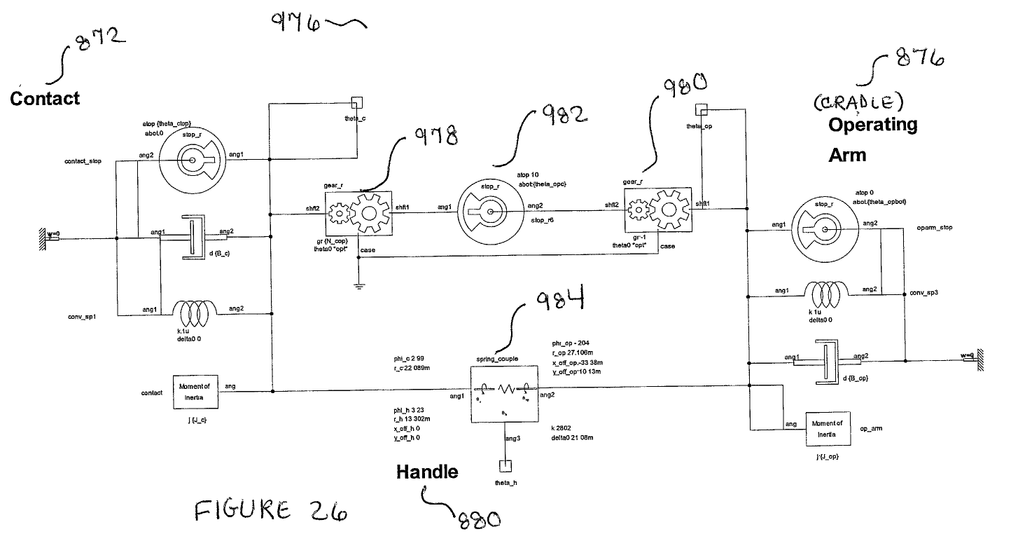

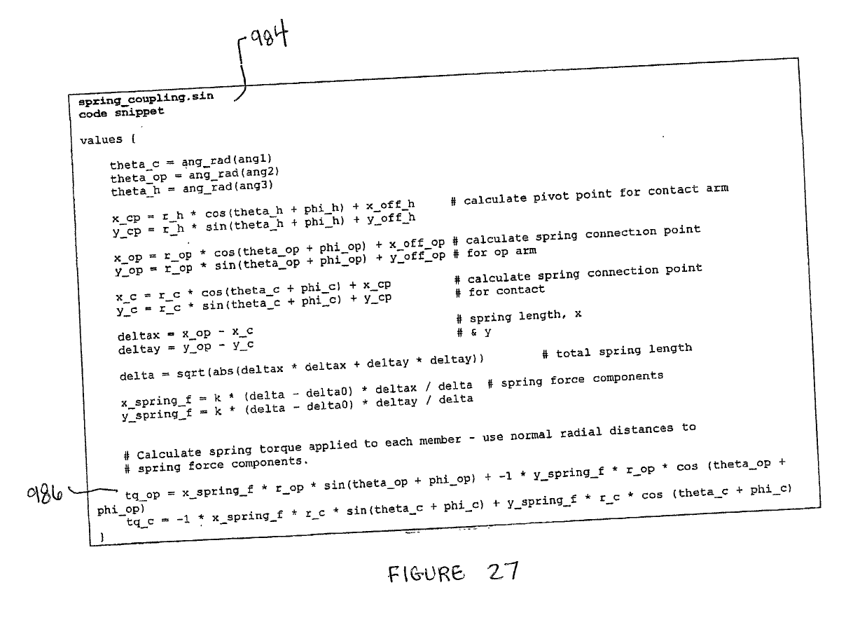

Referring to FIG. 26, the oparm_mech model 976 has two rotating elements, the contact 872 and cradle 876. When the cradle 876 is no longer held in place by the holding torque from the latch model 964, the spring_coupling model 984 (FIG. 27) torque moves the cradle 876 clockwise. The two gear elements 978, 980 and rotational stop element 982 between the contact 872 and cradle 876 approximate the mechanical interference at Point 870. The stop 982 models the distance the cradle 876 must travel before hitting the contact 872. The left-most gear element 978 models the ratio at which the two elements 978, 980 turn.

Between the contact blade 871 and cradle 876 is a spring (not shown) used to store energy for the trip event 834. The interaction of these three components (blade 871, cradle 876, and spring between points 874 and 878) is complicated because of the conversions between rotational and translational motion. The angular positions of the cradle 876, contact blade 871 and handle 880 are used to calculate the rectangular coordinates of the spring ends 874, 878. The x and y components are applied to a linear spring force/position equation 986 and combined to output a torque from the spring to each of the cradle 876 and contact blade 871 elements. Thus, the input to the operating mechanism model is the holding torque from the latch and the handle torque and the output is the contact position (angular).

The calculations for spring coupling are implemented in the spring coupling model 984, shown in FIG. 27. When the latch removes the holding torque, the cradle is free to collapse because of the contact blade/cradle spring. During the trip event, the cradle pushes the contact open and the spring then assists complete opening. Thus, the inputs to the spring coupling model are the angular positions of the cradle, handle, and contact blade and the output is the torque on contact and cradle due to spring tension.

The overall hierarchy presented within FIG. 13 combines all of the above modules into a symbol representing the mechanical components and behavior of the circuit breaker 810. Through the electrical pins “p” 946 and “m” 948 and ETU input “pos 1” 932, this module can be used with any ETU 78 with a solenoid 822 for a complete circuit breaker model 988.

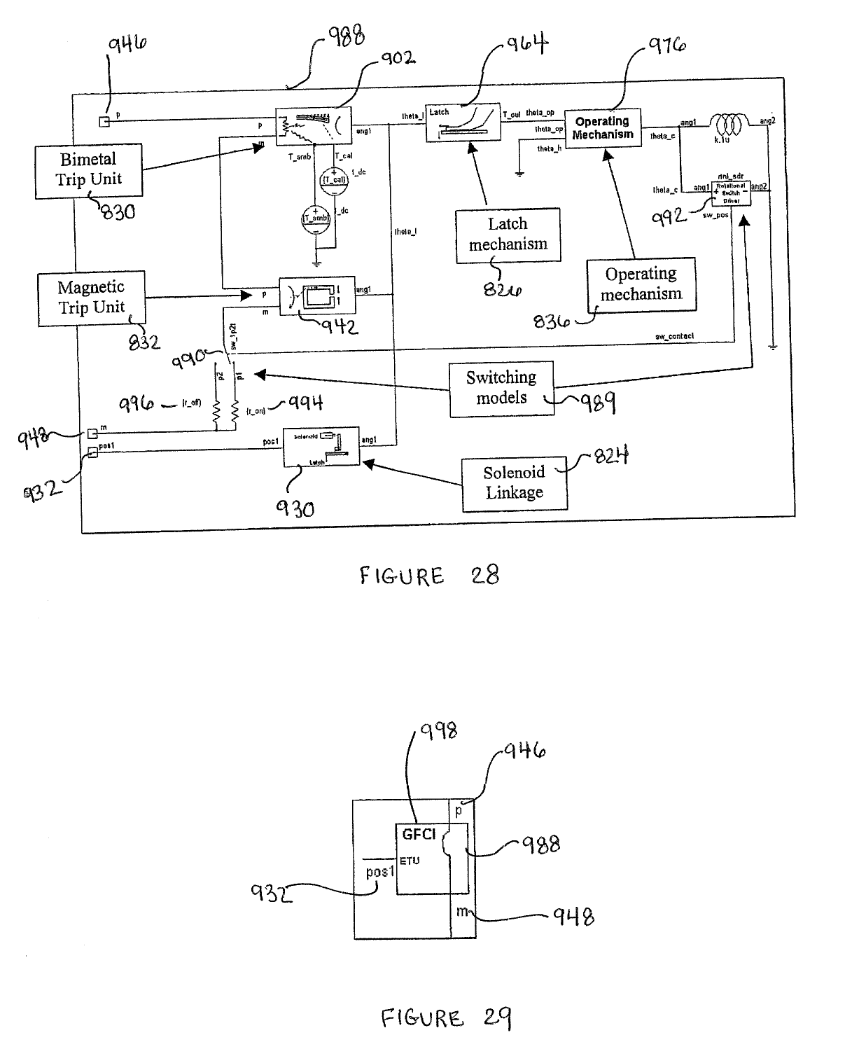

FIG. 28 shows the combination of mechanical sub-models (bimetal trip model 902, magnetic trip model 942, latch mechanism model 964, operating mechanism model 976, and solenoid mechanism model 930) in the system model 988. Additionally, the electrical switching behaviors of the contacts is modeled (shown collectively as switching models 989) using a switch 990 and driver 992. The rotational switch driver 992 compares the contact angle to a user-parameter and controls the switch 990 appropriately. The switch 990 changes the model's resistance between “r_on” 994 and “r_off” 996.

The system model 988 is wrapped and packaged in a single symbol 998, shown in FIG. 29. The symbol 998 represents the behavior of electrical switching using the load current 828 on pins “p” 946 and “m” 948 and ETU trip input on pin “pos1” 932.

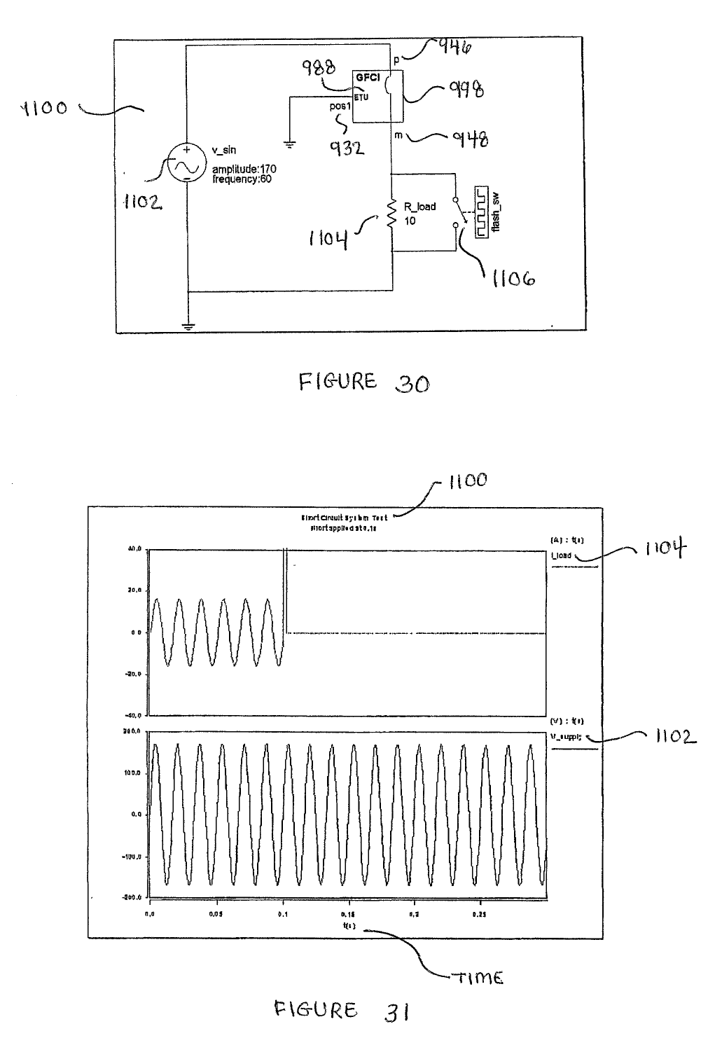

This model 988 can be used to test various behaviors, two of which are presented for demonstration. An exemplary short circuit test 1100 is shown in FIG. 30. A 120 VAC (rms) voltage 1102 is applied across the GFCI electrical connections 946, 948 and the 10 ohm load resistance 1104. At time=0.1 seconds, the switch 1106 (flash_sw) is closed, causing a short circuit. FIG. 31 shows the supply voltage 1102, V_supply, and the current through the load resistance, I_load 1104.

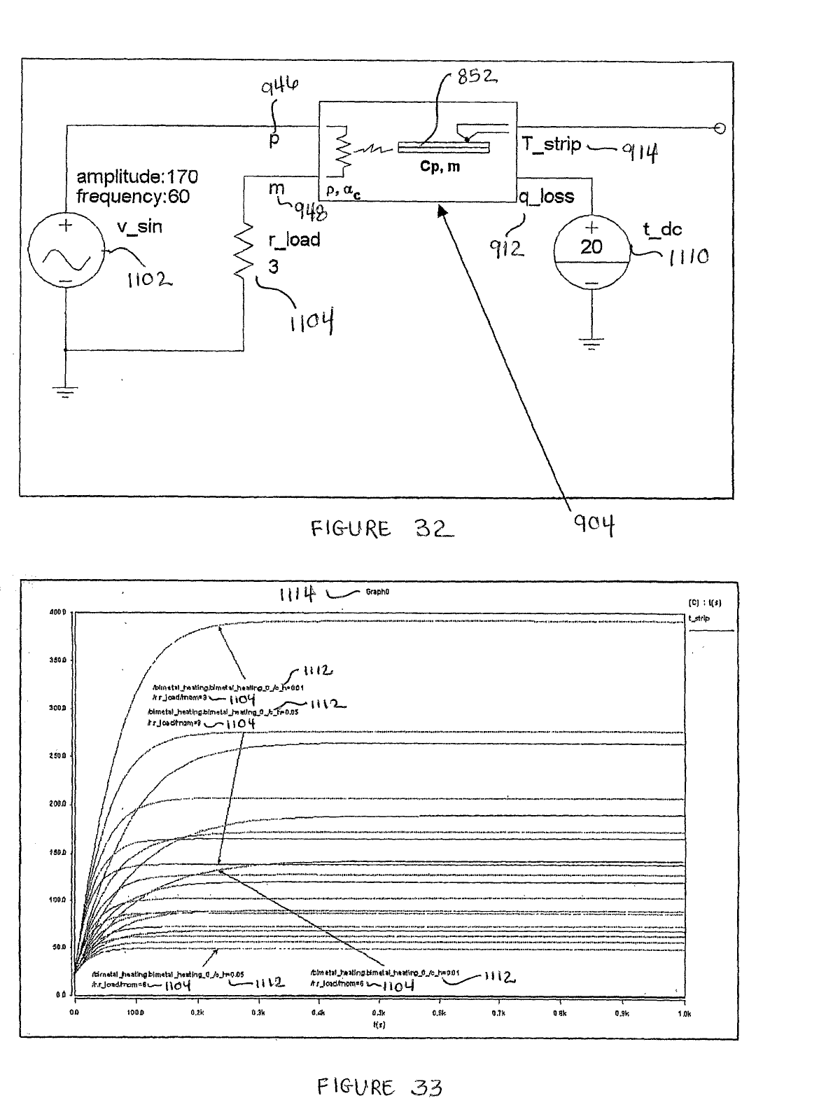

A second simulation, referring to FIG. 32, shows the ability to work with a single sub-model to refine the behavior of the overall system 988. The bimetal_heating model 904 (from FIGS. 17 and 18) is connected to a voltage source 1102 through a load resistance 1104. This results in a current flowing from pin “p” 946 through the bimetal 852 and out pin “m” 948. This current generates the temperature rise in the model 904. The temperature of the strip 852 is measured on “T_strip” 914.

The pin “q loss” 912 is held at a constant temperature (20 degrees C. at 1110) and conducts heat away from the bimetal strip 852 as losses. One of the parameters of this heat loss is “C_h” 1112, the conductive coefficient. In the simulation, this parameter 1112 is varied from 0.01 to 0.05 in 0.01 increments. The load resistance 1104, r_load, is also varied—in this case from 3 ohms to 6 ohms in 1 ohm increments.

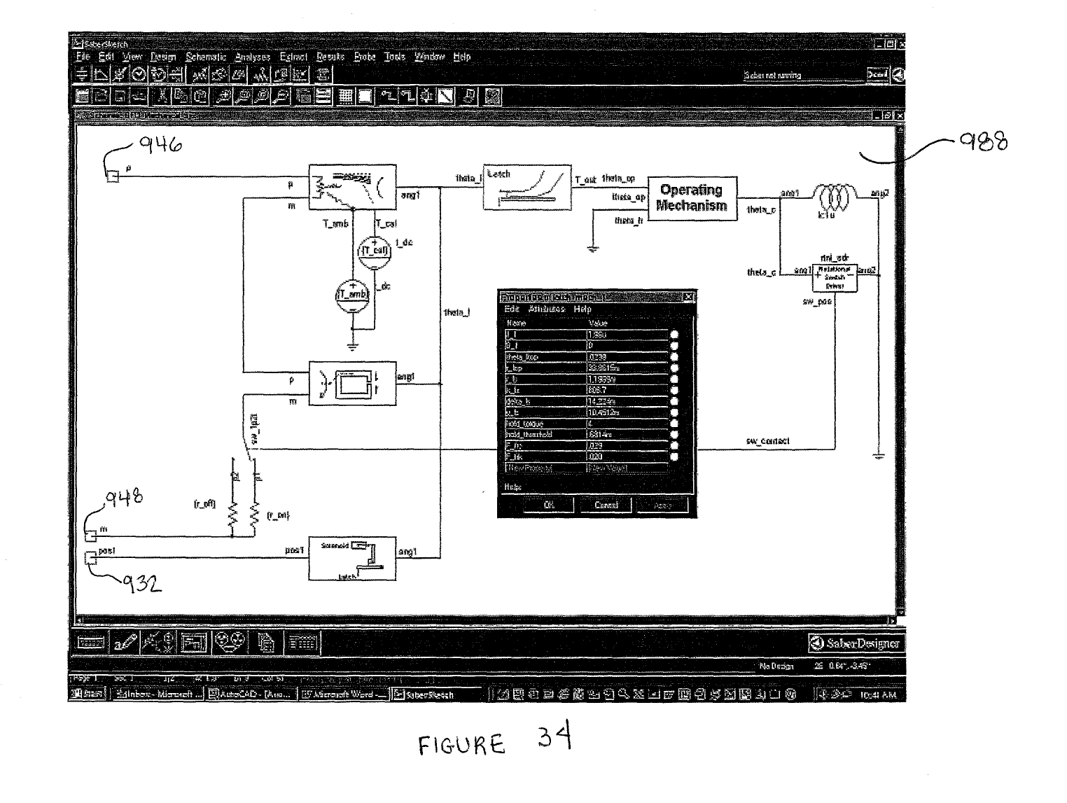

By varying the component parameters and graphing the result 1114 (FIG. 33), the designer is able to compare the shape of this curve 1114 to the desired response or to experimental data.

Using the above described modeling system 988, the time and tools required for circuit breaker design are decreased. This modeling approach introduces a novel use of simulation to combine the multi-disciplinary engineering efforts into one tool. An electrical engineer, without in-depth knowledge of the mechanical systems 830, 832, 826, 836, and 824, can now see the performance effects of changing some electrical design parameters on the overall circuit breaker response.

This modeling approach 988 allows low-level testing (as shown in FIG. 32). After this testing is complete, the system model 988 automatically updates and the designer can test the impact of low-level changes on the entire model 988.

Changes in the ETU 78 design can also be thoroughly tested with regard to the electromechanical interactions present in the solenoid 822 and linkage 824. For example, the switching action of the contacts may also affect the electronics (voltage spikes, etc.) in a manner that could be missed without total system modeling.

In addition to the elemental mechanical modeling of this work, embedded formulas and a spreadsheet automate many calculations required when moving from manufacturing drawings to simulation parameters. For instance, the bimetal trip unit 830 and magnetic trip unit 832 are designed primarily in IOS units. The designer may work only in these units—the conversions to metric for simulation can be performed without the designer's action reducing errors. Saber parameters are preferably labeled extensively with unit conventions and variable names. These variable names are linked to CAD drawings to allow quick identification of parametric information. FIG. 34 depicts a screen shot similar to FIG. 28 and additionally displays what the property editor looks like, along with the rest of SABER.

Thus, the modeling system 988 of this invention allows circuit breaker designers to manipulate, view, and optimize mechanical components and mechanical interactions at a component level. The width of a component can be directly minimized, damping can be added or removed, and multiple simulations can be run to optimize component values. The close link to CAD and automatic conversion from design parameters to simulation parameters is quick and less prone to error than conventional techniques.

The integrated modeling approach allows the designer to view the consequences of design changes. For example, design parameters, such as bimetal width and length may be input as parameters to the model and a simulation run. This simulation would be very fast and allow detailed insight to the bimetal behavior. Once the bimetal 852 is designed, the system model 988 is automatically updated and a system simulation, such as FIG. 30, shows the changes to trip time because of bimetal changes. The models of the present invention can become part of a higher level system design and analysis simulation, combined with electrical models in design and optimization. For example, a more global system model could represent the connections of the physical GFCI. Supply voltage is applied to the line/neutral pins and the load is connected to the load/n pins. If the load demonstrates fault conditions, the GFCI model will trip. Such a model could contain the electronics for the ETU and the mechanical system model. Thus, the input to such a model would be the load current through GFCI and the output would be swiched load current. As part of the ETU, a solenoid subsystem model could be included. The solenoid is powered by line voltage and switched by the electronics of the ETU. When the plunger is pulled in, the force is transmitted to the mechanical system to cause a trip. Thus, the input to a solenoid subsystem model would be line voltage and the output would be plunger force.

The present invention can be embodied in the form of computer-implemented processes and apparatuses for practicing those processes. The present invention can also be embodied in the form of computer program code containing instructions, embodied in tangible media, such as floppy diskettes, CD-ROM's, hard drives, or any other computer-readable storage medium, wherein, when the computer program code loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When the implementation is on a general-purpose microprocessor, the computer program code segments configure the microprocessor to create specific logic circuits.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for modeling a circuit breaker assembly and its components, the system comprising:
a computer generated and interactive system model, the system model comprising hierarchically arranged sub-models, each sub-model representing a different circuit breaker function;
a first pin for passing simulated load current to the system model; and,
a second pin for passing simulated load current from the system model.

2. The system of claim 1 wherein the sub-models includes at least one of a bimetal trip unit model, a magnetic trip unit model, a latch mechanism model, an operating mechanism model, and a solenoid linkage model.

3. The system of claim 2 wherein the sub-models includes the bimetal trip unit model, the bimetal trip unit model modeling behavior of a bimetal strip within the circuit breaker assembly.

4. The system of claim 3 further comprising a bimetal heating model and a bimetal deflection model accessible through the bimetal trip unit model.

5. The system of claim 4 wherein the bimetal heating model generates temperature rise and inputs temperature rise to the bimetal deflection model.

6. The system of claim 5 wherein the bimetal deflection model calculates force of the bimetal strip and applies the force to spring rate of the bimetal strip.

7. The system of claim 3 wherein the bimetal trip unit model determines temperature of the bimetal strip and calculates deflection and force exerted on the bimetal strip.

8. The system of claim 3 wherein the bimetal trip unit model includes a translational stop for modeling a gap located between the bimetal strip and a latch of the circuit breaker assembly.

9. The system of claim 2 wherein the sub-models includes the magnetic trip unit model, the magnetic trip unit model modeling interaction between a latch and a magnet within the circuit breaker assembly.

10. The system of claim 9 wherein the magnetic trip unit model uses the load current from the first pin and the second pin to excite a winding that generates a flux in a magnetic circuit within the circuit breaker assembly.

11. The system of claim 9 wherein the latch and the magnet are pivotal together.

12. The system of claim 9 wherein the sub-models includes the latch mechanism model, the latch mechanism model modeling behavior of a latch within the circuit breaker assembly.

13. The system of claim 12 wherein the latch is acted upon by the bimetal trip unit model and the magnetic trip unit model.

14. The system of claim 13 wherein the latch is further acted upon by an electronic trip unit within the circuit breaker assembly.

15. The system of claim 12 wherein the latch includes a pivot end, the pivot end adjacent to a magnet within the circuit breaker assembly.

16. The system of claim 15 wherein the pivot end is pushed towards the magnet by spring force.

17. The system of claim 15 wherein the latch includes an opposing end opposite the pivot end, the opposing end including a point, wherein position of the point is modeled within a latch position model.

18. The system of claim 2 wherein the sub-models includes the operating mechanism model, the operating mechanism model modeling interaction between a cradle, a contact blade, and a handle of a circuit breaker assembly.

19. The system of claim 18 wherein the cradle pulls a contact located on the contact blade open during a trip event.

20. The system of claim 18 wherein the cradle and the contact blade are connected by a spring coupling.

21. The system of claim 20 further comprising a spring coupling model within the operating mechanism model.

22. The system of claim 21 wherein the spring coupling model includes calculations for determining rectangular coordinates of ends of the spring coupling.

23. The system of claim 22 wherein the spring coupling model further includes an equation for calculating spring torque to the cradle and contact blade.

24. The system of claim 2 wherein the sub-models includes the solenoid linkage model, the solenoid linkage model modeling interactions between a solenoid lever and a latch lever of a circuit breaker assembly.

25. The system of claim 24 further comprising a third pin for passing solenoid force to the system model and to the solenoid linkage model.

26. The system of claim 1 further comprising simulation parameters representing each component.

27. The system of claim 26 wherein a change in simulation parameters within the sub-models updates behavior of the system model.

28. The system of claim 27 wherein simulation parameters includes component dimensions.

29. The system of claim 26 wherein simulation parameters are entered in IOS units.

30. The system of claim 29 wherein IOS units are converted by the system model to metric.

31. The system of claim 26 comprising a variable name for each simulation parameter, the system further comprising a computer aided drawing linked to each variable name.

32. The system of claim 26 wherein design parameters of each component are converted to simulation parameters by the system model.

33. The system of claim 1 wherein the system is embodied within a storage medium encoded with machine-readable computer program code.

34. A method of modeling a circuit breaker assembly, the method comprising:
representing each circuit breaker function to be modeled with a sub-model; and,
hierarchically organizing each sub-model within a system model.

35. The method of claim 34 further comprising providing the system model within a computer accessible symbol.

36. The method of claim 35 further comprising accessing the symbol to reach a selected sub-model.

37. The method of claim 34 further comprising testing the circuit breaker assembly, wherein testing the circuit breaker assembly comprises applying simulated load current through the system model.

38. The method of claim 34 further comprising varying component parameters within a sub-model.

39. The method of claim 38 further comprising updating the system model subsequent varying component parameters within a sub-model.

40. The method of claim 38 wherein varying component parameters comprises changing dimensions of a circuit breaker component.

41. The method of claim 38 wherein varying component parameters comprises altering electrical design parameters.

42. The method of claim 34 further comprising testing the circuit breaker assembly, outputting experimental data, and graphing the experimental data.

43. The method of claim 34 wherein representing each circuit breaker function to be modeled with a sub-model comprises providing a bimetal trip unit model for modeling behavior of a bimetal strip within the circuit breaker assembly.

44. The method of claim 43 further comprising arranging a bimetal heating model and a bimetal deflection model within the bimetal trip unit model.

45. The method of claim 44 further comprising accessing the bimetal heating model for generating simulated temperature rise and inputting the simulated temperature rise to the bimetal deflection model.

46. The method of claim 45 further comprising accessing the bimetal deflection model for calculating simulated force of the bimetal strip and applying the simulated force to spring rate of the bimetal strip.

47. The method of claim 43 comprising accessing the bimetal trip unit model for determining simulated temperature of the bimetal strip and calculating simulated deflection and force exerted on the bimetal strip.

48. The method of claim 43 further comprising providing a translational stop in the bimetal trip unit model for modeling a gap located between the bimetal strip and a latch of the circuit breaker assembly.

49. The method of claim 34 wherein representing each circuit breaker function to be modeled with a sub-model comprises providing a magnetic trip unit model for modeling interaction between a latch and a magnet within the circuit breaker assembly.

50. The method of claim 34 wherein representing each circuit breaker function to be modeled with a sub-model comprises providing a latch mechanism model for modeling behavior of a latch within the circuit breaker assembly.

51. The method of claim 34 wherein representing each circuit breaker function to be modeled with a sub-model comprises providing an operating mechanism model for modeling interaction between a cradle, a contact blade, and a spring coupling connecting the cradle and contact blade of the circuit breaker assembly.

52. The method of claim 51 further comprising arranging a spring coupling model within the operating mechanism model.

53. The method of claim 52 further comprising accessing the spring coupling model for determining rectangular coordinates of ends of the spring coupling.

54. The method of claim 53 further comprising accessing the spring coupling model for calculating spring torque to the cradle and contact blade.

55. The method of claim 34 wherein representing each circuit breaker function to be modeled with a sub-model comprises providing a solenoid linkage model modeling interactions between a solenoid lever and a latch lever of a circuit breaker assembly.

56. The method of claim 34 further comprising embodying the system model and sub-models within a storage medium encoded with machine-readable computer program code.

57. A storage medium encoded with machine-readable computer program code for modeling a circuit breaker assembly, the storage medium including instructions for causing a computer to implement a method comprising:
representing each circuit breaker function to be modeled with a sub-model; and,
hierarchically organizing each sub-model within a system model.

58. The storage medium of claim 57 further comprising instructions for causing a computer to implement:
providing the system model within a computer accessible symbol.

59. The storage medium of claim 58 further comprising accessing the symbol to reach a selected sub-model.

60. The storage medium of claim 57 further comprising instructions for causing a computer to implement:
testing the circuit breaker assembly, wherein testing the circuit breaker assembly comprises applying simulated load current through the system model.

61. The storage medium of claim 57 further comprising instructions for causing a computer to implement:
varying component parameters within a sub-model.

62. The storage medium of claim 61 further comprising instructions for causing a computer to implement:
updating the system model subsequent varying component parameters within a sub-model.

63. The storage medium of claim 61 further comprising instructions for causing a computer to implement:
changing dimensions of a circuit breaker component.

64. The storage medium of claim 61 further comprising instructions for causing a computer to implement:
altering electrical design parameters.

65. The storage medium of claim 57 further comprising instructions for causing a computer to implement:
testing the circuit breaker assembly, outputting experimental data, and graphing the experimental data.

66. The storage medium of claim 57 further comprising instructions for causing a computer to implement:
providing a bimetal trip unit model for modeling behavior of a bimetal strip within the circuit breaker assembly.

67. The storage medium of claim 66 further comprising instructions for causing a computer to implement:
arranging a bimetal heating model and a bimetal deflection model within the bimetal trip unit model.

68. The storage medium of claim 57 further comprising instructions for causing a computer to implement:
providing a magnetic trip unit model for modeling interaction between a latch and a magnet within the circuit breaker assembly.

69. The storage medium of claim 57 further comprising instructions for causing a computer to implement:
providing a latch mechanism model for modeling behavior of a latch within the circuit breaker assembly.

70. The storage medium of claim 57 further comprising instructions for causing a computer to implement:
providing an operating mechanism model for modeling interaction between a cradle, a contact blade, and a spring coupling connecting the cradle and contact blade of the circuit breaker assembly.

71. The storage medium of claim 70 further comprising instructions for causing a computer to implement:
arranging a spring coupling model within the operating mechanism model.

72. The storage medium of claim 57 further comprising instructions for causing a computer to implement:
providing a solenoid linkage model modeling interactions between a solenoid lever and a latch lever of a circuit breaker assembly.

73. A system for modeling a circuit breaker assembly and its components, the system comprising:
a computer generated and interactive system model, the system model comprising hierarchically arranged sub-models, each sub-model representing a different circuit breaker function; and,
simulation parameters within each sub-model, each simulation parameter representing an aspect of each component.

74. The system of claim 73 wherein design parameters of a component are converted to simulation parameters by the system model.

75. The system of claim 73 wherein a change in simulation parameters within the sub-models updates behavior of the system model.
